(19) United States
(12) Patent Application Publication
(10) Pub. No.: US 2018/0068274 A1
(43) Pub. Date: Mar. 8, 2018

(54) System and Method for Document Processing

(71) Applicant: 401KPLANS.COM LLC, Hingham, MA (US)

(72) Inventor: Scott Ronald Buffington, Hingham, MA (US)

(21) Appl. No.: 15/699,421

(22) Filed: Sep. 8, 2017

Related U.S. Application Data
(60) Provisional application No. 62/384,908, filed on Sep. 8, 2016.

(51) Int. Cl. G06Q 10/10; G06Q 40/06

(52) U.S. Cl. CPC G06Q 10/1057; G06Q 40/06

(57) ABSTRACT

The disclosure relates to processing of information and documents, e.g., in analyzing financial plans such as retirement plans, presenting relevant information relating to a user, e.g., in 408(b)(2) data, and tools for enhancing user understanding and decision making with respect to the same. Machine (e.g., optical recognition) of content of such forms and information is used in some aspects. Rankings and recommendations are automatically generated in other aspects.

### RELATED APPLICATIONS

This application claims the benefit of and priority to U.S. Provisional Application No. 62/384,908, filed on Sep. 8, 2016, entitled “System and Method for Document Processing”, which is incorporated by reference herein in its entirety.

### TECHNICAL FIELD

The present application relates to the automated processing of documents and information, especially in the context of financial documents, and including where such documents are controlled by regulation, provide inconsistent information, a need for interpretation for required evaluation and decision making.

### BACKGROUND

Financial documents such as those relating to persons' retirement accounts, savings, retirement funds, fund management, investments or similar aspects can be quite complicated, especially for those not specialized in the financial planning or investment or retirement fund management fields. Government agency regulations further add to the complexity of the documents themselves, and also to the difficulty of making sense of the documents due to various formats and labeling of data by financial firms and the inconsistent information provided and the implications thereof.

In an example, a small business manager or their designated agent may be researching a suitable retirement plan (e.g., a 401 k plan) for his or her employees. It is necessary or helpful for the manager or the agent to understand the current costs of their plan and ensure that they are “reasonable”. Then financial firms proposing their services would provide a number of informational documents and materials containing the plan's policies, fees, requirements and other factors that may be weighed in deciding on a best plan for the small business. For an accurate estimate of proposed total costs, a manager or sponsor of a plan examines the current asset allocation by fund and fund category. Since each plan is different, and each small business need can vary, it can require a significant investment of time by the manager or sponsor of a plan to understand the available plans, compare the investments and choose accordingly. The form and format of the documentation can vary as well between plan providers, including paper and/or electronic forms and documentation available. This makes comparing plans and terms and fees for the same a difficult task to do manually or to automate.

Furthermore, the laws require that the manager of a plan (e.g., a small business plan sponsor or agent of) understand and act in a fiduciary manner towards affected employees of the business when choosing and managing a retirement plan such as a 401 k plan. Failure to understand or make proper decisions by the manager can subject the manager to significant legal consequences with respect to his or her duties. In an example, if the manager currently offers or chooses a 401 k plan that charges excessive or inappropriate fees, as considered from the legal perspective of a participant, the manager could be held liable for certain breeches of duty with regard to the selection and management of his or her employees' retirement accounts. Litigation has placed added pressure on managers to select and operate their companies' retirement funds in a conservative and risk averse way. In addition, plan sponsors have been required to make decisions with regard to their plans (e.g., regarding plan fees) so as to determine whether plan fees are legally “reasonable”, which is a difficult if not impossible determination for a plan sponsor who lacks sufficient legal or business training and tools to answer such questions.

Plan managers are supposed to also establish documented and legally prudent processes for continued monitoring of the fees and investments of their selected retirement fund plans, which is an ongoing and changing exercise that is beyond the capabilities of many managers, especially small business owners. The present disclosure provides, inter alia, for automation of these and other aspects.

There remain no ideal, consistent or simple solutions currently available to business owners, especially those who own or manage small businesses, but who still wish to offer 401 k or similar retirement fund services to the business employees. Processing information, documents and forms relating to the establishment, selection and handling of retirement accounts remains a significant challenge for business owners, who can find themselves personally liable for errors of judgment, even if such errors are determined by a complex legal system in hindsight. Section 408(b)(2) of Employee Retirement Income Security Act (ERISA) requires covered service providers to identify and disclose all direct and indirect compensation received in connection with a plan. Again, many sponsors, especially at smaller firms, do not have the background, experience, support or tools to expertly navigate the complex requirements of the law with respect to their ERISA obligations and other duties, nor do they fully appreciate the fees and costs involved with a retirement plan. These persons bear this responsibility and liability while simultaneously needing to attend to the management of their firms.

This invention seeks to eliminate or alleviate some or all of the above challenges in selecting, understanding and managing a fund such as a retirement or 401 k or similar fund, especially for smaller organizations with limited resources or technical expertise in these matters.

### SUMMARY

The present disclosure is concerned with processes for automated online review, selection assistance, compliance assistance and risk mitigation relating to financial plans, including in reviewing and decision making of information found therein. In an embodiment, the systems and methods disclosed herein are directed inter alia to aiding small business owners and sponsors in selecting and managing retirement account plans while maximizing the benefits thereof to their employees and businesses, and while minimizing or avoiding risks of managing the same.

In one aspect, the invention permits automated parsing and processing of form documentation and data, e.g., as in a 408(b)(2) document and similar documents. In another aspect, an online marketplace may be established through the present systems and methods.

In one or more aspects, a method comprises: receiving, at a processor, a source document that includes human readable information regarding an investment plan; generating, by said processor, a computer readable file, corresponding to said source document, including computer readable information regarding the investment plan based at least in part on the human readable information; parsing, by said processor, portions of the computer readable information to extract one or more selection criteria for said investment plan; receiving, at said processor, from a data store containing information regarding other investment plans, selection criteria for said other investment plans, and determining or receiving for said other investment plans, selection criteria for said other investment plans; comparing, by said processor, the selection criteria of the investment plan with comparable selection criteria of said other investment plans; generating, from said processor, an output signal indicative of a result of said comparing step above, and identifying a selected investment plan from a group of available investment plans including the investment plan and the other investment plans; outputting, from said processor an electronic file comprising a record of the selection made; and generating a certificate certifying said comparison and said selection.

In one or more aspects, at least one non-transitory computer readable storage medium stores processor-executable instructions that, when executed by at least one processor, result in a method comprising: receiving a source document that includes human readable information regarding an investment plan; generating a computer readable file, corresponding to said source document, including computer readable information regarding the investment plan based at least in part on the human readable information; parsing portions of the computer readable information to extract one or more selection criteria for said investment plan; receiving from a data store containing information regarding other investment plans, selection criteria for said other investment plans, and determining or receiving for said other investment plans, selection criteria for said other investment plans; comparing the selection criteria of the investment plan with comparable selection criteria of said other investment plans; generating an output signal indicative of a result of said comparing step above, and identifying a selected investment plan from a group of available investment plans including the investment plan and the other investment plans; outputting an electronic file comprising a record of the selection made; and generating a certificate certifying said comparison and said selection.

In one or more aspects, a system comprises: at least one computer hardware processor configured to execute instructions that result in a method comprising: receiving a source document that includes human readable information regarding an investment plan; generating a computer readable file, corresponding to said source document, including computer readable information regarding the investment plan based at least in part on the human readable information; parsing portions of the computer readable information to extract one or more selection criteria for said investment plan; receiving from a data store containing information regarding other investment plans, selection criteria for said other investment plans, and determining or receiving for said other investment plans, selection criteria for said other investment plans; comparing the selection criteria of the investment plan with comparable selection criteria of said other investment plans; generating an output signal indicative of a result of said comparing step above, and identifying a selected investment plan from a group of available investment plans including the investment plan and the other investment plans; outputting an electronic file comprising a record of the selection made; and generating a certificate certifying said comparison and said selection.

In at least some embodiments, the method permits automated parsing and processing of form documentation and data, e.g., as in a 408(b)(2) document and/or similar documents. In at least some embodiments, the method may be used by a marketplace. In at least some embodiments, the method further comprises establishing the online marketplace.

In at least some embodiments, the method further comprises generating, a record of the one or more characteristics of the plan.

In at least some embodiments, the selected investment plan is a 401k plan.

In at least some embodiments, the selection criteria include a cost metric.

In at least some embodiments, generating said certificate comprises executing one or more steps required under a regulatory scheme for due diligence in choosing plans among available plans.

In at least some embodiments, the method may further comprise receiving, by a processor, a plurality of source documents each associated with a respective one of the plurality of other investment plans and including selection criteria for the respective one of the plurality of other investment plans.

In at least some embodiments, the method may further comprise, for each of the plurality of source documents, generating, by a processor, a computer readable file, corresponding to said source document, including computer readable information regarding the investment plan based at least in part on the human readable information; and parsing, by said processor, portions of the computer readable information to extract one or more selection criteria for said investment plan.

In at least some embodiments, the cost information and/or other selection criteria in one of the plurality of source documents may have a positioning, a format and/or a labeling scheme that is different than a positioning, a format and/or labeling scheme, respectively, of the cost information and/or other selection criteria in another of the source documents.

Various features of at least some embodiments and/or other aspects of the invention address the following and other concerns: total cost of a retirement plan; breaking down the total costs into those incurred by the investment options and costs related to servicing the plan, whether the costs of a retirement plan are reasonable or competitive with other plans; documenting a prudent procedure for selection and management and monitoring of a retirement plan's fees and investment options.

In at least some embodiments, the method may further include providing a dashboard view in a graphical user interface. In at least some embodiments, the dashboard view may include information reporting all advisor activity, market data trends and/or investment manager reporting.

In at least some embodiments, the method may further include providing one or more graphical tools (in a graphical user interface) or other type(s) of tools that may be activated by an advisor and/or other user to control compensation of an advisor, at least in part. In at least some embodiments, the method may include one or more tools that may be activated by a user to define the compensation of the advisor based at least in part on plan size. In at least some embodiments, the method may further include providing aggregate compensation market data as a function of plan size, service model and/or other criteria.

In at least some embodiments, the method may further include providing one or more graphical tools that may be activated by an advisor and/or other user to pre-select or otherwise indicate one or more preferred providers and/or one or more preferred investment options. In at least some embodiments, the method may further include providing one or more graphical tools that may be activated by an advisor and/or other user to make changes to one or more of the indications.

In at least some embodiments, any one or more graphical tools that is disclosed herein and activatable by a user to indicate a request, a selection and/or other information may be supplemented and/or replaced by a tool that is not a graphical tool but activatable by a user to indicate the request, the selection and/or the other information.

In at least some embodiments, the method may further include providing one or more graphical tools that may be activated by an advisor and/or other user to indicate one or more preferred providers and/or one or more preferred investment options. In at least some embodiments, the method may further include providing one or more graphical tools that may be activated by an advisor and/or other user to make changes to one or more of the indications.

In at least some embodiments, the method may further include providing one or more graphical tools, which may be activated by an advisor and/or other user to indicate one or more criteria (lowest total cost, lowest investment cost, lowest service cost, highest rated technology, highest rated participant education, highest rated record keeping services and/or any other criteria) based at least in part on which the user requests to have the providers ranked and/or otherwise compared. In at least some embodiments, lowest total cost may comprise lowest total cost for a given plan size (or size range). In at least some embodiments, lowest total cost may comprise lowest total cost for a given plan size (or size range) and given types of investments (or investment range).

In at least some embodiments, the method may further include automatically determining investment mapping at least in part and/or providing one or more graphical tools, which may be activated by an advisor and/or other user to indicate a requested investment mapping at least in part. In at least some embodiments, performing investment mapping prior to comparing costs associated with plans helps to increase the accuracy of the comparison.

In at least some embodiments, the method may further include providing one or more graphical tools, which may be activated by an advisor and/or other user to indicate a request for ongoing monitoring of plan fees.

In at least some embodiments, the method may provide an innovative point of sale application to assist financial advisors and their clients with their fiduciary obligations and mitigating risks.

This Summary is intended to provide an overview of at least some of the subject matter of the present patent application. It is not intended to provide an exclusive or exhaustive explanation of the invention or embodiments thereof.

Thus, while certain aspects and embodiments have been presented and/or outlined in this Summary, it should be understood that the present aspects and embodiments are not limited to the aspects and embodiments in this Summary. Indeed, other aspects and embodiments, which may be similar to and/or different from, the aspects and embodiments presented in this Summary, will be apparent from the description, illustrations and/or claims, which follow.

Further limitations and disadvantages of conventional and traditional approaches will become apparent to one of skill in the art, through comparison of such systems with some aspects of the present invention as set forth in the remainder of the present application with reference to the drawings.

However, while various features and/or advantages are described in this Summary and/or will become apparent in view of the following detailed description and accompanying drawings, it should be understood that such features and/or advantages are not required in all aspects and embodiments.

Any aspects and/or embodiments that are described in this Summary and do not appear in the claims that follow are preserved for later presentation in this application or in one or more continuation patent applications. Any aspects and/or embodiments that are not described in this Summary and do not appear in the claims that follow are also preserved for later presentation or in one or more continuation patent applications.

### BRIEF DESCRIPTION OF THE DRAWINGS

Reference is made to the following detailed description in connection with the accompanying drawings, in which:

FIGS. 1-7 illustrate an exemplary workflow for a tool and interface for carrying out one or more present embodiments;

FIG. 8 illustrates an exemplary architecture on which the present inventions may be implemented, in accordance with at least some embodiments;

FIGS. 9-32 illustrate exemplary processes according to a non-limiting embodiment of the present invention;

FIG. 33 illustrates a flowchart of a method, in accordance with some embodiments;

FIG. 34 illustrates a block diagram of a computer architecture, in accordance with some embodiments;

FIG. 35 illustrates a block diagram of a system architecture, in accordance with some embodiments;

FIGS. 36-37 illustrate exemplary processes according to another non-limiting embodiment of the present invention;

FIG. 38 illustrates a flowchart of a method, in accordance with some embodiments; and

FIG. 39 illustrates a flowchart of a method, in accordance with some embodiments.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure.

### DETAILED DESCRIPTION

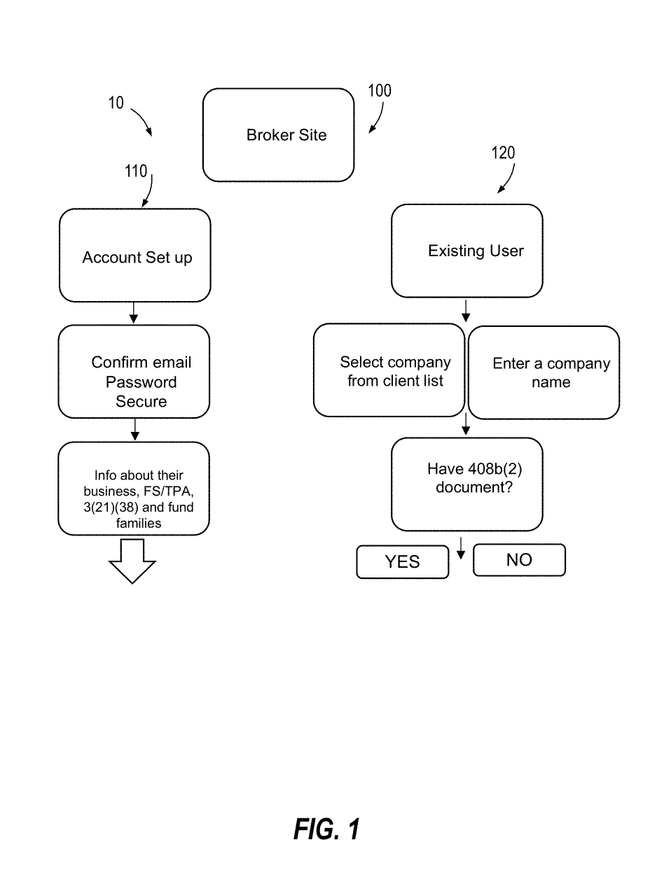

FIG. 1 illustrates an exemplary group of steps 10 in an automated environment for selection of a financial services plan, e.g., a 401 k retirement plan, in accordance with at least some embodiments. A broker site 100 is provided, which allows for the setup of new user accounts 110 or the administration of an existing user account 120. These steps may be programmed in a computer program or machine readable instructions to be presented as user interface elements in a computing environment such as on a touch-screen interface or video display interface. A user may interact with said user interface elements (sometimes referred to hereinafter as elements (or element if singular)) by clicking, pressing or otherwise actuating one or more such elements to cause a pre-determined sequence of further steps to be executed. In an example, the elements on FIG. 1 are implemented as a first page or view in a user interface of a running program environment, which can lead to other pages or views of the same.

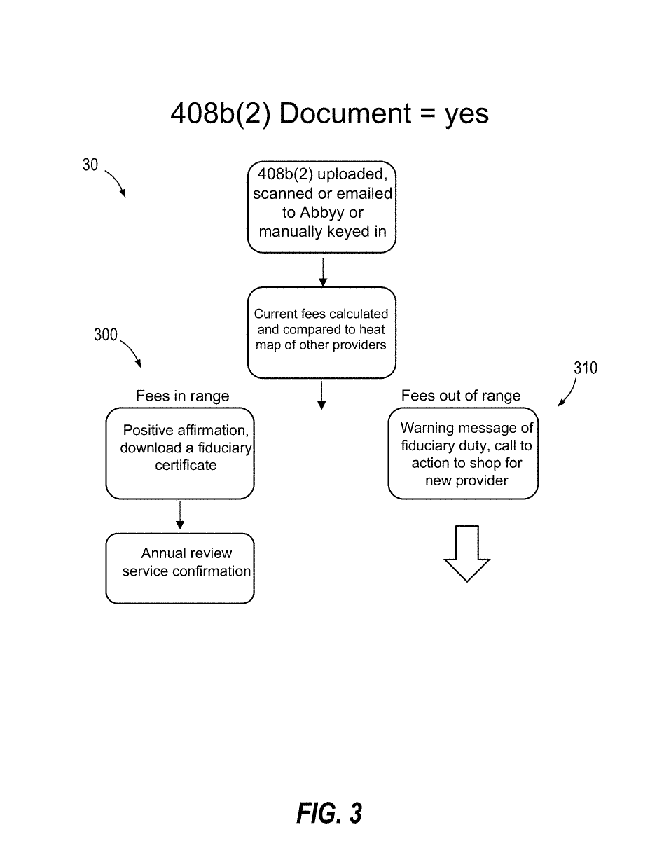

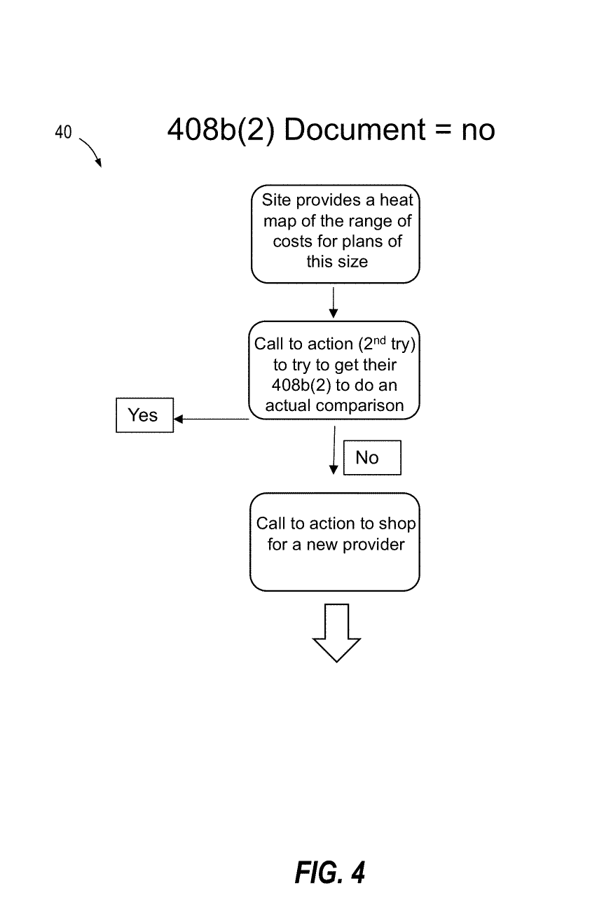

The process for establishing a new account 110, or account setup, includes prompting a user seeking a new account to choose and confirm log in credentials such as an email and password setup, as well as collecting information regarding the new account, which can include information about the new account holder's business and other information (which may include information about the business' fund families). A process for administration of an existing customer account 120 can include prompting the account holder (sometimes referred to herein as the user) to select one of a plurality of registered or known customer companies from a client list, and alternatively, to enter a customer company name. Then the account holder is asked if a 408(b)(2) or similar documents are to be reviewed or processed or analyzed. If the account holder responds or otherwise indicates “yes” (e.g., via a user interface element), the process may proceed to steps shown in FIG. 3, which will be further discussed below. If the account holder responds or otherwise indicates “no” (e.g., via a user interface element), the process may proceed to logic and steps shown FIG. 4.

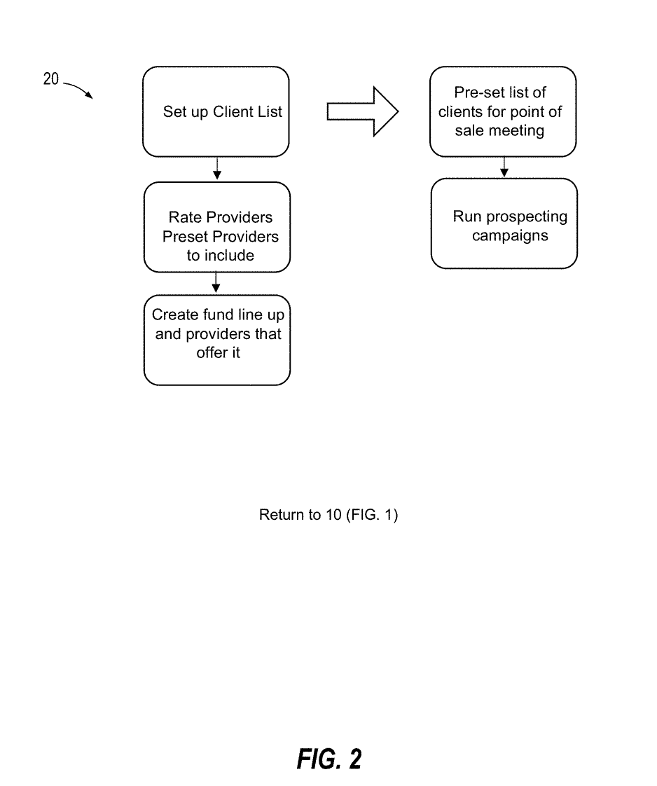

FIG. 2 illustrates further client list options 20 that the process may make available (e.g., via user interface elements) to a user, in accordance with at least some embodiments. These include the option of setting up a client list, rating providers, and creating a fund lineup (and a list of providers that offer the fund lineup). Also, these may include the option of selecting a pre-set list of clients for a point of sale meeting and running prospecting campaigns according to another aspect.

As discussed above, if when asked (as shown in FIG. 1 and discussed above) whether a 408(b)(2) or similar documents are to be reviewed or processed or analyzed, the account holder (user), indicates “yes” (i.e., that a 408(b)(2) document is to be reviewed or processed or analyzed), the process may proceed to steps shown in FIG. 3, which will now be discussed.

FIG. 3 illustrates an exemplary group of steps for processing a 408(b)(2) form 30, in accordance with at least some embodiments. In at least some embodiments, and in accordance with current government regulations, a 408(b)(2) form includes information indicating various details associated with a retirement plan including the costs that are associated with the retirement plan (e.g., direct and/or indirect compensation payable to a provider under a 401 plan offered by that provider).

Referring to FIG. 3, the 408(b)(2) form may be received in any manner(s). For example, it may be uploaded, scanned or emailed to a service or destination indicated by the process. Alternately, the form may be manually keyed in. Next, the form is parsed and information indicative of costs is extracted therefrom. Using such information, the current fees are calculated and compared to others, for example depicting the same on a heat map or other graphical indicator of relative fee structures.

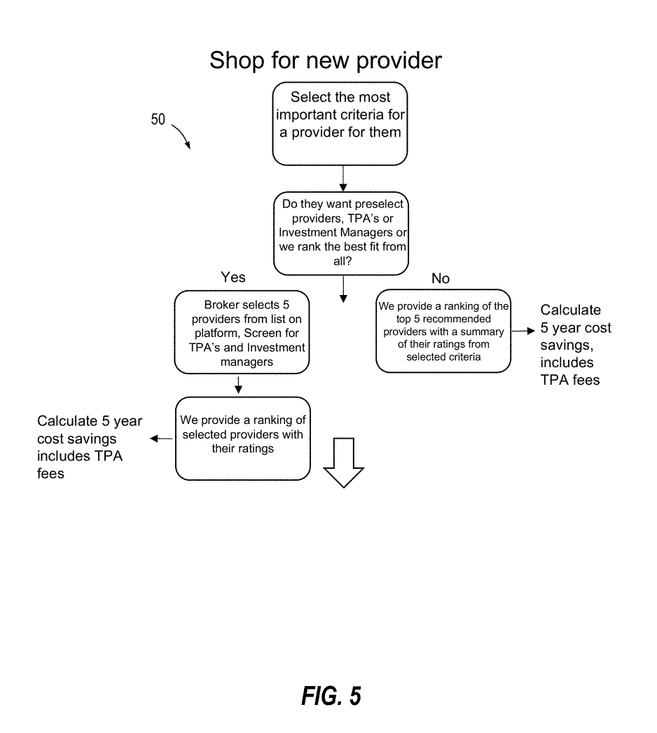

The steps may further include determining whether the fees are in a given (e.g., acceptable) range at 300, and if so, the user is presented a positive affirmation and a fiduciary certificate is downloaded. This is followed by an annual review service confirmation. If it is determined that the fees are out of a given range at 310, the user is warned by a warning message regarding potential fiduciary liability and a prompt to change or select a new plan provider so as to reduce or avoid said liability, sometimes referred to herein as shopping for a new provider, and the process may proceed to steps shown in FIG. 5, which will be further discussed below.

FIG. 4 illustrates a sequence of exemplary logic and steps 40 that may be performed and prompts and/or other information that may be presented where no 408(b)(2) document is uploaded or provided, in accordance with at least some embodiments.

Referring to FIG. 4, the logic and steps may include characterizing or otherwise determining a size of the plan, determining other plans that are each of a size that is comparable to the size of the plan, and comparing the costs of such other plans, for example depicting the same on a heat map or other graphical indicator of relative fee structures.

The logic and steps may further include prompting the user (or otherwise trying) to get a 408(b)(2) document for the current plan from the provider of the current plan to enable an actual comparison of the costs of the plan to those of other plans (e.g., the other plans of comparable size). If the 408(b)(2) document for the plan is subsequently obtained, the process may proceed to the steps in FIG. 3, to allow the document to be reviewed or processed or analyzed. If the 408(b)(2) document for the plan is not obtained, the user may be prompted to shop for a new provider, and the process may proceed to steps shown in FIG. 5, which will now be discussed.

FIG. 5 illustrates exemplary logic or steps 50 that may be performed in the event a user decides to shop for a new plan provider, in accordance with at least some embodiments. The logic or steps may include prompting a user to enter or choose a most important criterion for the provider and prompting a user to indicate whether the user prefers to preselect providers, third party administrators (TPA's) or investment managers that are to be considered, or whether the user prefers to not preselect but rather to choose from a ranking based on a best fit of plans from all providers, third party administrators (TPA's) and investment managers.

A ranking of providers can be generated and presented once the relevant data are analyzed. If a user had indicated a preference to preselect, a broker can be shown a list of providers, TPA's and/or investment managers and provided with opportunity to select a subset (e.g., five) of the providers, TPA's and/or investment managers. A ranking of the selected providers may be generated using relevant data and presented to the broker. In at least some embodiments, the preselected providers may be ranked based at least in part on their costs and/or a client's projected future cost savings. In some embodiments, projected future costs savings may be a calculation of costs (including TPA fees) that the client would be projected to save over five (5) years (or other period of time).

Or, if the user had indicated a preference to not preselect, a list of best (e.g., five) recommended providers and a brief summary of each can be presented. In at least some embodiments, the best recommended providers may be ranked based at least in part on their costs and/or a client's projected future cost savings. In some embodiments, projected future costs savings may be a calculation of costs (including TPA fees) that a client would be projected to save over five (5) years (or other period of time).

In at least some embodiments, one of the preselected, recommended and/or ranked providers may then be selected by a user to provide a new 401(k) plan.

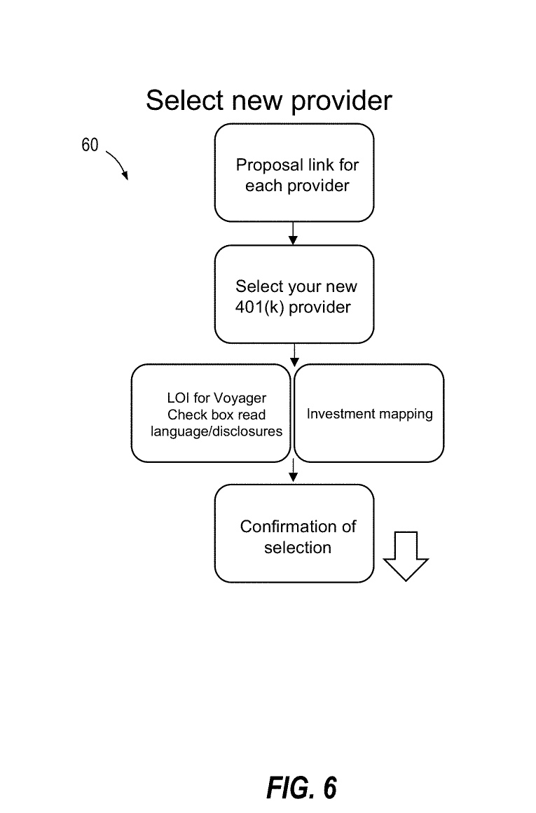

FIG. 6 illustrates an exemplary sequence of steps 60 that may be performed in facilitating selection of a new 401(k) plan, in accordance with at least some embodiments. A provider for the plan can be selected based on criteria as described before, or based on a ranking according to one or more metrics or recommendations. In at least some embodiments, the sequence of steps may include providing a list of providers that may be selected (e.g., the preselected, recommended and/or ranked providers discussed above with respect to FIG. 5), and a respective proposal link for each such provider. The sequence may further include prompting the client to select one of the providers (e.g., by activating a graphical tool in a graphical user interface). An indication of the user's selection may thereafter be received and a letter of intent (LOI) may be generated in response at least thereto. The steps may further include investment mapping, which may comprise determining, for each particular investment type in the old plan (e.g., stock fund, bond fund, combination fund) in which money is currently invested, a corresponding or other investment type in the new plan (e.g., stock fund, bond fund, combination fund) into which to transfer the money currently invested in the particular investment type in the old plan. The client may be prompted to read disclosures and/or legal requirements and to confirm their selection. Disclosures and legal requirements are reviewed by the client, and the client can confirm that such have been read and his or her selection (e.g., by checking a box and activating another type of graphical tool in a graphical user interface)

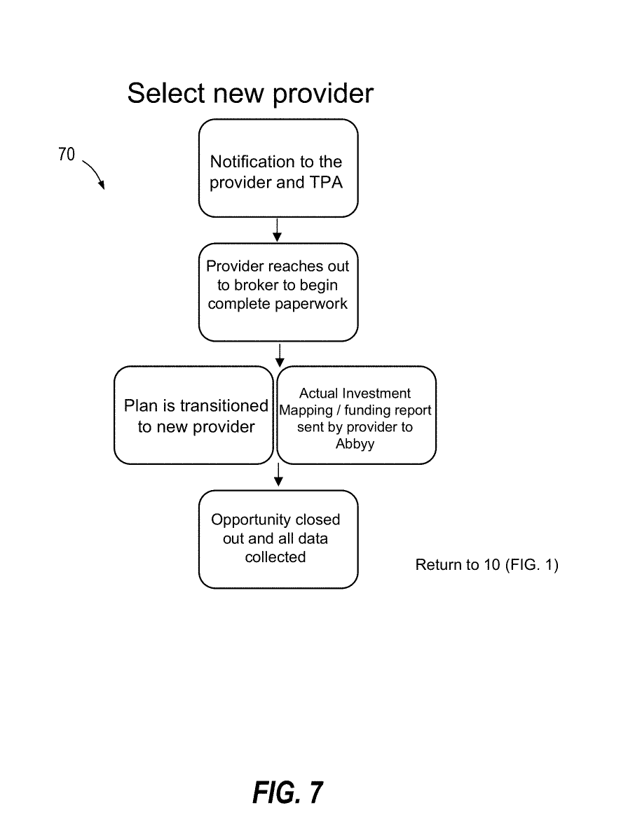

FIG. 7 illustrates the continuing steps that may be performed in selecting a new plan provider 70, in accordance with at least some embodiments. A notification of the client's selection is sent to the provider and third party plan administrator. The provider can then return a message or contact the client directly to set up particulars of the service provided, to begin preparation of complete paperwork or to complete any incomplete paperwork. If the provider returns a message, such message is received. If the client was using a prior (different) plan, the plan is then transitioned to the new provider in response at least in part to the message and/or the direct contact from the provider. The continuing steps further include closing out the opportunity (i.e., other candidates are closed out of the transaction as the selection would be made at this point) and collecting some or all data associated with the transaction and/or the process that was used (start to finish) and led to the transaction. An actual investment and/or a funding report may be sent by the provider to an ABBYY or other data and/or document capture system. The method and system can then return to the beginning with the above available options, or others.

Further aspects of the invention may include presentation and organization of data and information, processing of documents, and generating viewable outputs, e.g., printed or on a display screen containing the results of any automated or manual processing steps.

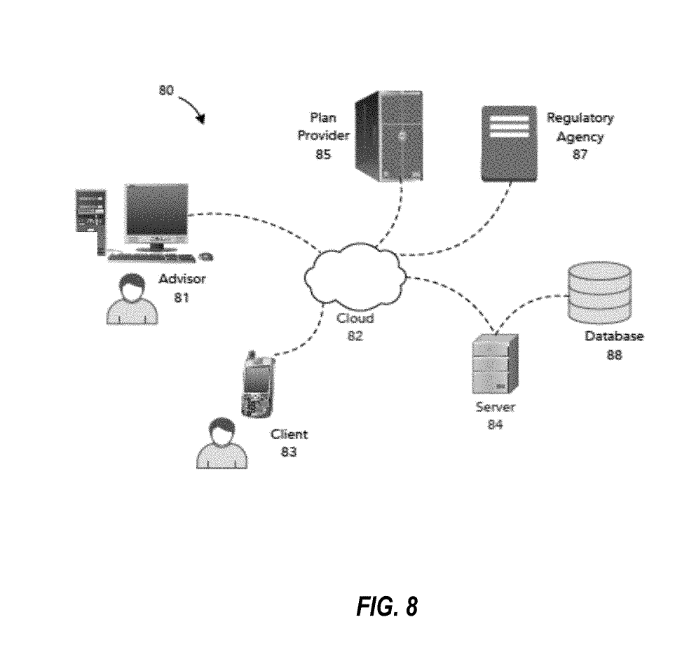

FIG. 8 illustrates an exemplary architecture 80 for providing the present methods and systems, in accordance with at least some embodiments.

Referring now to FIG. 8, the architecture 80 may include a cloud based communication network 82, which may include one or several wired, wireless, local or wide area network components and network communication infrastructure. The network 82 can deliver data and information among the interconnected components shown. The network may include the Internet, World Wide Web, cellular, Wi-Fi, corporate, private, public, government networks, or combinations thereof using any one or more accepted communication protocols. Preferably the connections to the network 82 are secure or authenticated to avoid losses or privacy concerns.

Parties such as an advisor 81 and a client or customer 83 may connect to the network using their respective communication or client devices. Such devices are equipped with hardware and software so as to support said communication and so as to present and process information relating to the services described herein. A user interface, e.g., a graphical user interface (GUI) may be included in any of the present devices. An input/output (I/O) capability assists the users of the devices in interacting with the system.

A plan provider 85 and/or regulatory agency 87 may further connect to the architecture 80 to exchange data therewith as described herein. A server 84 can be used as part of the present architecture, including some storage unit or database 88 that stores information relating to any of the above parties, rules in a rules engine, or other data and instructions to coordinate and facilitate the overall operation of the architecture 80.

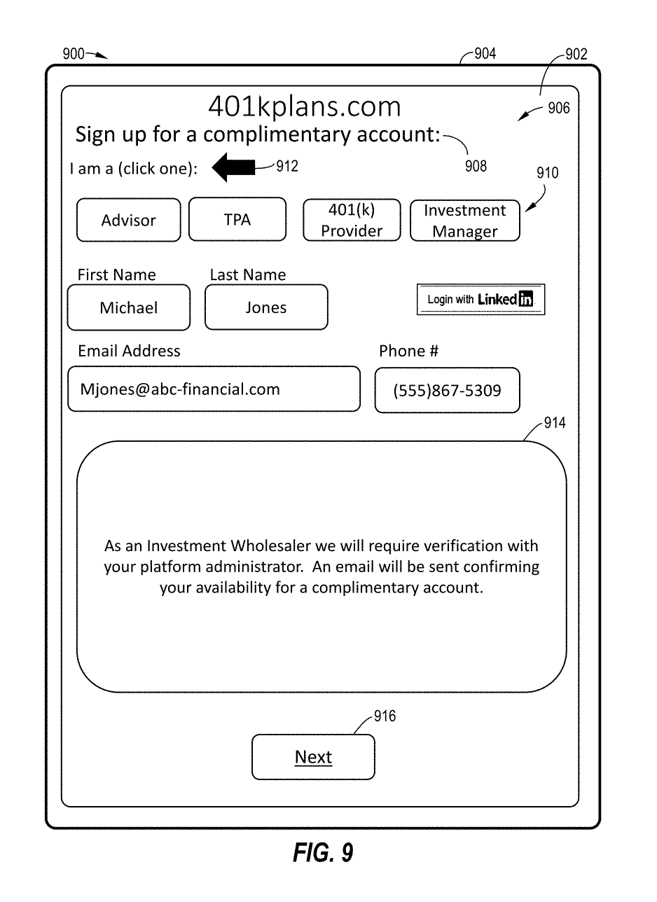

FIGS. 9 through 33 illustrate a non-limiting example of a computer program output and interface according to the present system and method. The example of a computer program output and interface are illustrated as a sequence of views in one or more graphical user interface provided by one or more computing device, e.g., computing device 900, in accordance with at least some embodiments.

As discussed, the actions and processes herein may be implemented in a number of ways, which these examples are neither exhaustive nor limiting of. The present sequence is merely to further illustrate that which is invented, including possible ways to implement the invention on a machine or automated processing system.

Thus, the invention is not limited to the sequence(s) of views shown. In at least some embodiments, the disclosed processes and/or steps may be performed in any order that is practicable and/or desirable.

In at least some embodiments, one or more of the views or features or other portions thereof, may be used without one or more others of the views or features other portions thereof.

In at least some embodiments, sub-blocks of logic, processor circuits and memory allocations are provided to carry out the present steps.

Referring now to FIG. 9, the computing device 900 may include a display 902, a camera (not shown), a speaker (not shown), a microphone (not shown), an on/off button (not shown) that can be activated to turn the computing device 900 on and off, and a case 904 that supports (directly and/or indirectly) each of the above.

The display 902 is shown displaying a view 906 that may be generated and/or displayed at, or otherwise in association with, the process for establishing a new account 110 (FIG. 1). In particular, the view 906 includes one or more prompts 908 or other instructions for the user in regard to signing up with instructions for an account, and further includes one or more graphical tools 910, which may be selected or otherwise activated (e.g., by a tap, entering information or other gesture and/or any combination thereof) by a user to indicate or otherwise provide a selection and/or other requested information.

The view may further include one or more arrows or other indicators 912 to guide the user in providing the requested information (and/or to indicate one or more active fields or one or more other active graphical tools), a notification or other information 914 regarding a next step in the sign-up process, and a graphical tool 916, which may be activated by a user to indicate a desire to proceed or otherwise navigate to another (e.g., next) view in the graphical user interface.

The method may further include receiving one or more indication that one or more graphical tools (described herein or otherwise) that have been activated by a user and/or receiving an indication of a selection and/or other requested information that has been provided by the user via activation of one or more graphical tools (described herein or otherwise). The method may further include responding based at least in part to the one or more indication and/or the received information. In at least some embodiments, responding may comprise responding as described herein.

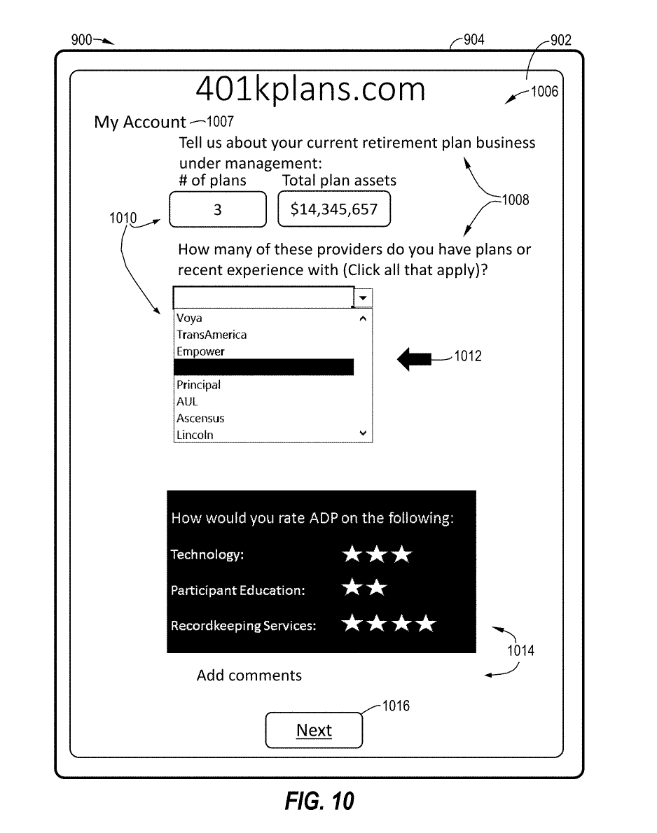

FIG. 10 shows the computing device 900 displaying another (e.g., a next) view 1006 that may be generated and/or displayed at, or otherwise in association with, the process for establishing a new account 110 (FIG. 1), the process for administration of an existing user account 120 (FIG. 1) and/or the process for further client list options 20 (FIG. 2).

Referring to FIG. 10, the view 1006 includes a header or other information that identifies the view and/or its location 1007 within the graphical user interface. The view 1006 further includes one or more prompts or other instructions 1008 for the user to provide information about the user's business, one or more graphical tools 1010, which may be activated by a user to provide the requested information. The view may further include one or more arrows or other indicators 1012 to guide the user in providing the requested information (and/or to indicate one or more active fields or one or more other active graphical tools), one or more graphical tools 1014, which may be activated by a user to provide ratings and/or other requested information, and a graphical tool 1016, which may be activated by a user to indicate a desire to navigate to another (e.g., next) view in the graphical user interface.

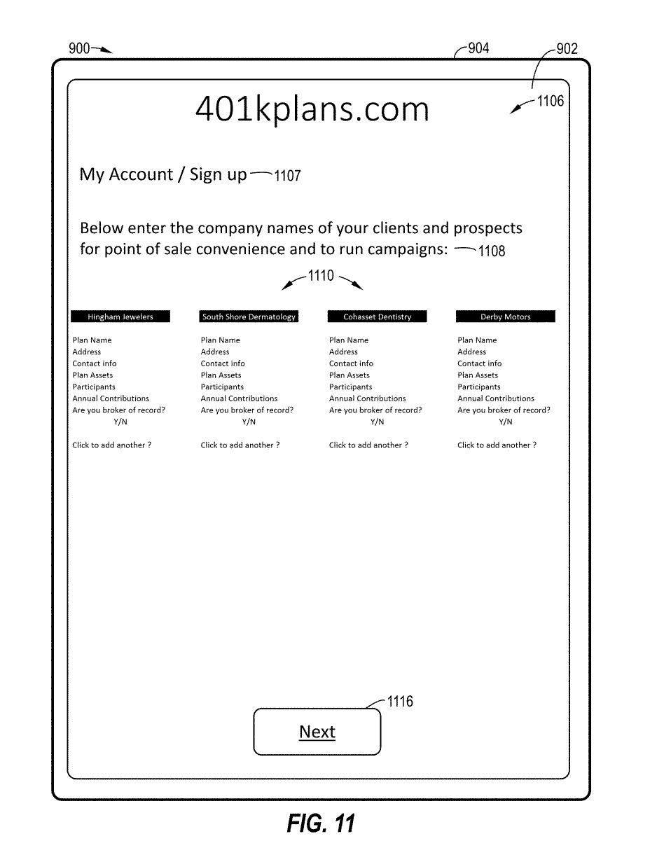

FIG. 11 shows the computing device 900 displaying a view 1106 that may be generated and/or displayed at, or otherwise in association with, the process for establishing a new account 110 (FIG. 1), the process for administration of an existing user account 120 (FIG. 1) and/or the process for further client list options 20 (FIG. 2).

Referring to FIG. 11, the view 1106 includes a header or other information that identifies the view and/or its location 1107 within the graphical user interface. The view 1106 further includes one or more prompts or other instructions 1108 for the user to provide information about each company (e.g., a company name, a name of a plan used by the company, and other information relating to the plan) that is a client of and/or a prospect of the user for point of sale convenience and/or to run campaigns. The view 1106 further includes one or more graphical tools 1110, which may be activated by the user to provide the requested information, and a graphical tool 1116, which may be activated by the user to indicate a desire to navigate to another (e.g., next) view in the graphical user interface.

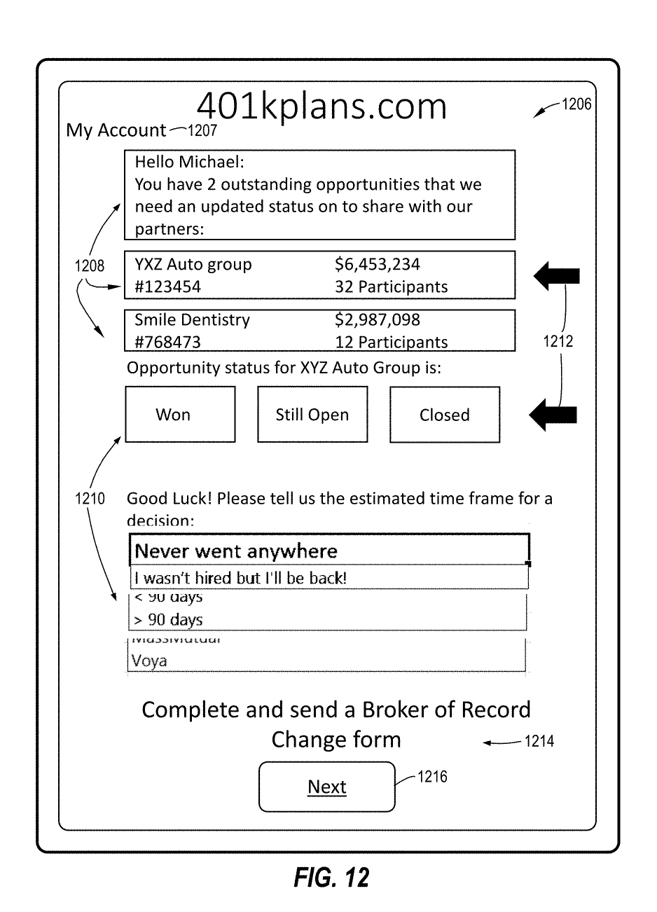

FIG. 12 shows the computing device 900 displaying a view 1206 that may be generated and/or displayed at, or otherwise in association with, the process for further client list options 20 (FIG. 2).

Referring to FIG. 12, the view 1206 includes a header or other information that identifies the view and/or its location 1207 within the graphical user interface. The view 1206 further includes one or more prompts or other instructions 1208 for the user to provide information in regard to the status of one or more outstanding opportunities, and one or more graphical tools 1210, which may be activated by a user to provide the requested information. The view 1206 may further include one or more arrows or other indicators 1212 to guide the user in providing the requested information (and/or to indicate one or more active fields or one or more other active graphical tools).

The view 1206 may further one or more prompts or other instructions 1214 for the user to submit a change form, and a graphical tool 1216, which may be activated by a user to indicate a desire to navigate to another (e.g., next) view in the graphical user interface.

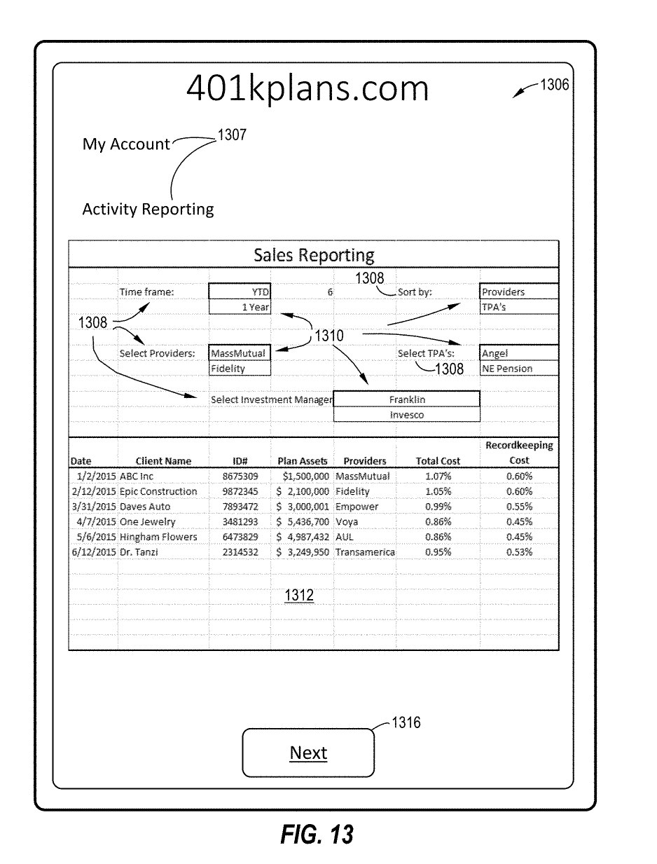

FIG. 13 shows the computing device 900 displaying a view 1306 that may be generated and/or displayed at, or otherwise in association with, the process for administration of an existing user account 120 (FIG. 1) and/or the process for further client list options 20 (FIG. 2).

Referring to FIG. 13, the view 1306 includes a header or other information that identifies the view and/or its location 1307 within the graphical user interface. The view 1306 further includes one or more prompts or other instructions 1308 for the user to provide information specifying criteria (specified time frame, sorting criteria, selected providers, TPA's, investment manager(s) and/or any other criteria) to be used in providing a report (a sales reporting or any other type of report) that may be desired by the user, and one or more graphical tools 1310, which may be activated by the user to provide some or all of the requested information. The view 1306 may further include a report 1312 generated by the process and/or system in response at least in part to, and/or based at least in part on, the criteria specified by the user. The generated report 1312 may have any form(s), for example but not limited to a table having a plurality of rows and columns. The view 1306 may further include a graphical tool 1316, which may be activated by the user to indicate a desire to navigate to another (e.g., next) view in the graphical user interface.

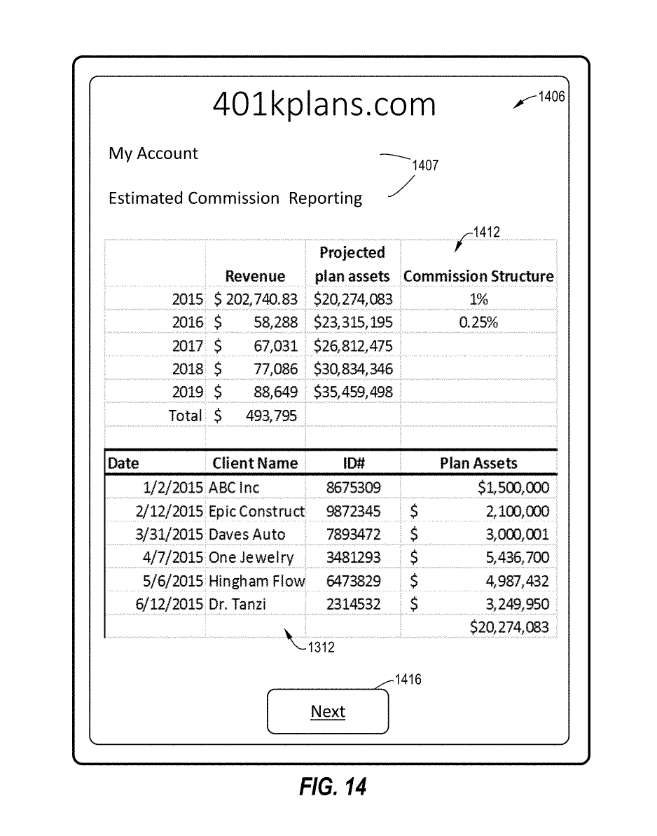

FIG. 14 shows the computing device 900 displaying a view 1406 that may be generated and/or displayed at, or otherwise in association with, the process for administration of an existing user account 120 (FIG. 1) and/or the process for further client list options 20 (FIG. 2).

Referring to FIG. 14, the view 1406 includes a header or other information that identifies the view and/or its location 1407 within the graphical user interface. The view 1406 further includes the report 1312 (or a portion thereof, the size of which may be enlarged, e.g., as shown, compared to the size of the report 1312 (or portion thereof) in FIG. 13) and another report 1412 that may be generated by the process and/or system in response at least in part to, and/or based at least in part on, criteria specified by the user. The generated report 1412 may have any form(s), for example but not limited to a table having a plurality of rows and columns. The view 1406 may further include a graphical tool 1416, which may be activated by the user to indicate a desire to navigate to another (e.g., next) view in the graphical user interface.

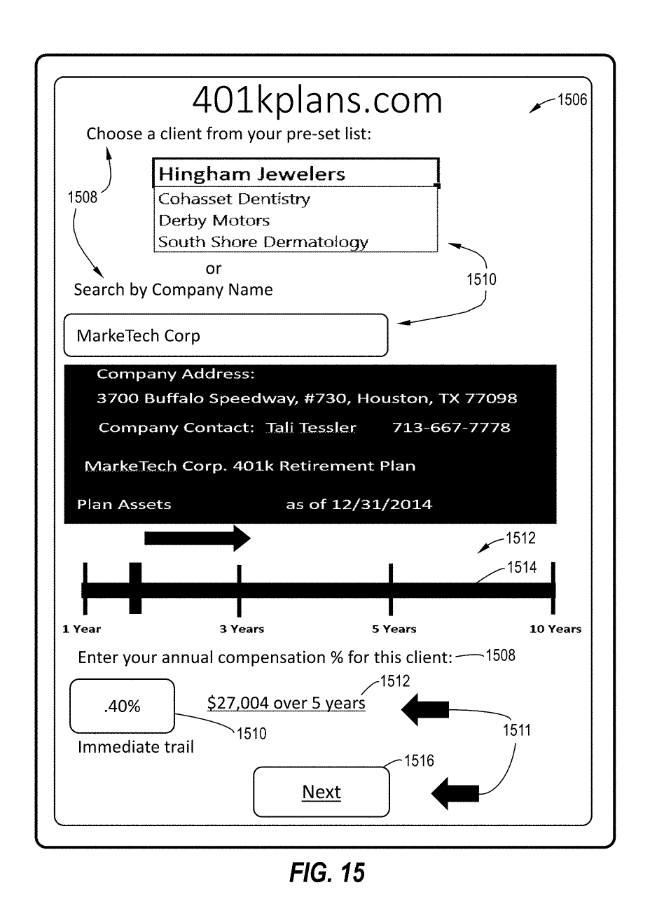

FIG. 15 shows the computing device 900 displaying a view 1506 that may be generated and/or displayed at, or otherwise in association with, the process for administration of an existing user account 120 (FIG. 1) and/or the process for further client list options 20 (FIG. 2).

Referring to FIG. 15, the view 1506 includes one or more prompts or other instructions 1508 for the user to provide information specifying criteria (client name, annual compensation percentage associated with that client and/or any other criteria) to be used in providing a report that may be desired by the user, and one or more graphical tools 1510, which may be activated by the user to provide some or all of the criteria. The view 1506 may further include one or more arrows or other indicators 1511 to guide the user in providing the requested information (and/or to indicate one or more active fields or one or more other active graphical tools), and a report 1512 generated by the process and/or system in response based at least in part on the criteria specified by the user. The generated report 1512 may have any form(s), for example but not limited to, a form that includes a timeline 1514. The view 1506 may further include a graphical tool 1516, which may be activated by the user to indicate a desire to navigate to another (e.g., next) view in the graphical user interface.

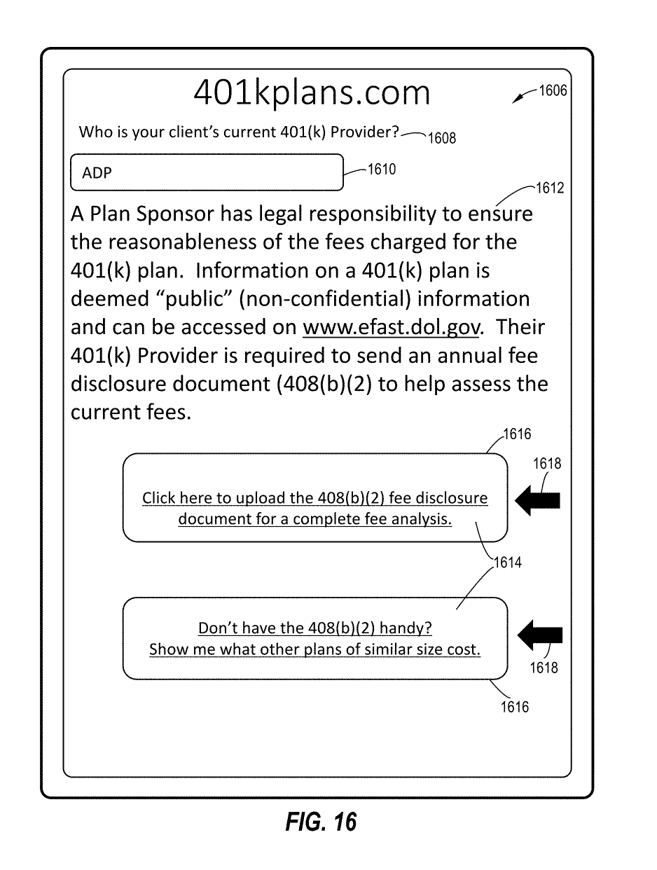

FIG. 16 shows the computing device 900 displaying a view 1606 that may be generated and/or displayed at, or otherwise in association with, the process for administration of an existing user account 120 (FIG. 1), e.g., in association with a step for selecting or otherwise entering a company name of client and/or a step that asks if a 408(b)(2) or similar documents are to be reviewed or processed or analyzed.

Referring to FIG. 16, the view 1606 includes one or more prompts or other instructions 1608 for the user to indicate a client's current 401(k) provider, and one or more graphical tools 1610, which may be activated by the user to provide the requested information.

The view 1606 may further include information 1612 regarding or otherwise disclosing legal responsibilities pertaining to a plan sponsor for a 401(k) plan and a provider of the 401(k) plan and legal requirements pertaining to an annual fee disclosure document 408(b)(2) that must be provided by the provider of the plan.

The view 1606 may further include one or more prompts or other instructions 1614 for the user to indicate whether a 408(b)(2) or similar documents (e.g., for a current plan) are to be reviewed or processed or analyzed, and one or more graphical tools 1616, which may be activated by the user to provide the requested information. The view 1606 may further include one or more arrows or other indicators 1618 to guide the user in providing the requested information (and/or to indicate one or more active fields or one or more other active graphical tools).

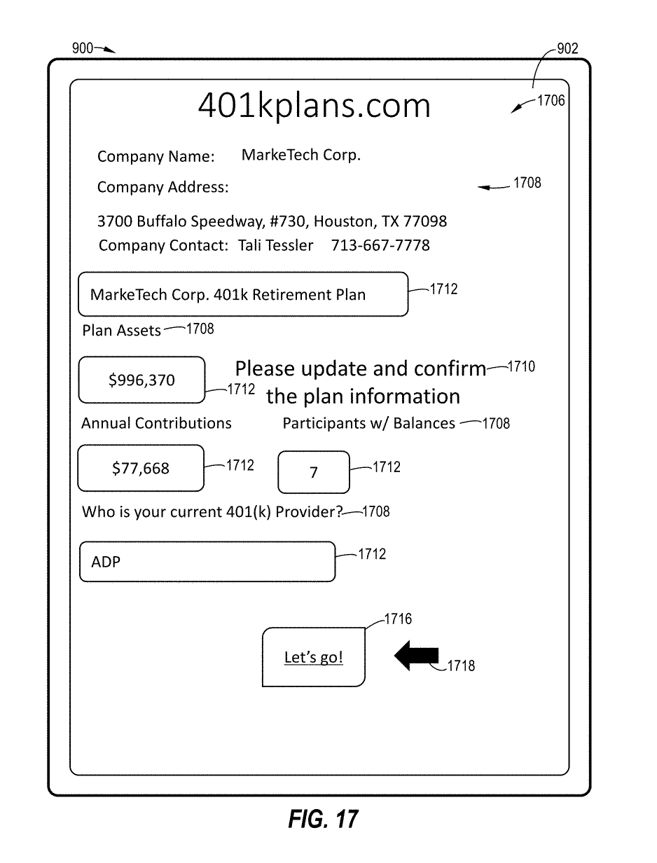

FIG. 17 shows the computing device 900 displaying a view 1706 that may be generated and/or displayed at, or otherwise in association with, the process for administration of an existing user account 120 (FIG. 1), e.g., in association with a step for selecting or otherwise entering a company name of client. In some embodiments, the view 1706 may be generated and/or displayed after a user has provided a name of a client, e.g., after the user has provided a name of a client by activating one or more of the one or more graphical tools in the view 1606 (FIG. 16).

Referring to FIG. 17, the view 1706 includes information 1708 associated with the client company selected by the user (a name of the company, address of the company, a contact at the company and a telephone number and/or other contact information for the contact, the current provider of the company's 401(k) plan, the asset amount in the company's 401(k) plan, annual contributions to the company's 401(k) plan, number of participants in the company's 401(k) plan and/or any other information).

The view 1706 further includes one or more prompts or other instructions 1710 for the client to confirm or update the information associated with the client, and one or more graphical tools 1712, which may be activated by the client to provide updated information. The view 1706 may further include a graphical tool 1716, which may be activated by the client to indicate confirmation of the information and/or a desire to proceed, and one or more arrows or other indicators 1718 to guide the client in providing the requested information (and/or to indicate one or more active fields or one or more other active graphical tools).

In at least some embodiments, the view 1706, or one or more portions thereof, may be intended for a representative of the client, rather than or in addition to the user. In view thereof, in some embodiments, the view 1706, or one or more portions thereof, may be generated and/or displayed on a computing device of the client, alternatively to or in addition to on the computing device 900. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device. In some embodiments, the method may further include responding to the reply or other information from the client, as if the reply or other information was provided by the user and/or in any other manner as may be appropriate.

For that matter, in at least some embodiments, any view disclosed herein, or one or more portions thereof, may be intended for a representative of the client, rather than or in addition to the user. In some embodiments, any such view, or one or more portions thereof, may be generated and/or displayed on a computing device of the client, alternatively to or in addition to on the computing device 900. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device. In some embodiments, the method may further include responding to the reply or other information from the client, as if the reply or other information was provided by the user and/or in any other manner as may be appropriate.

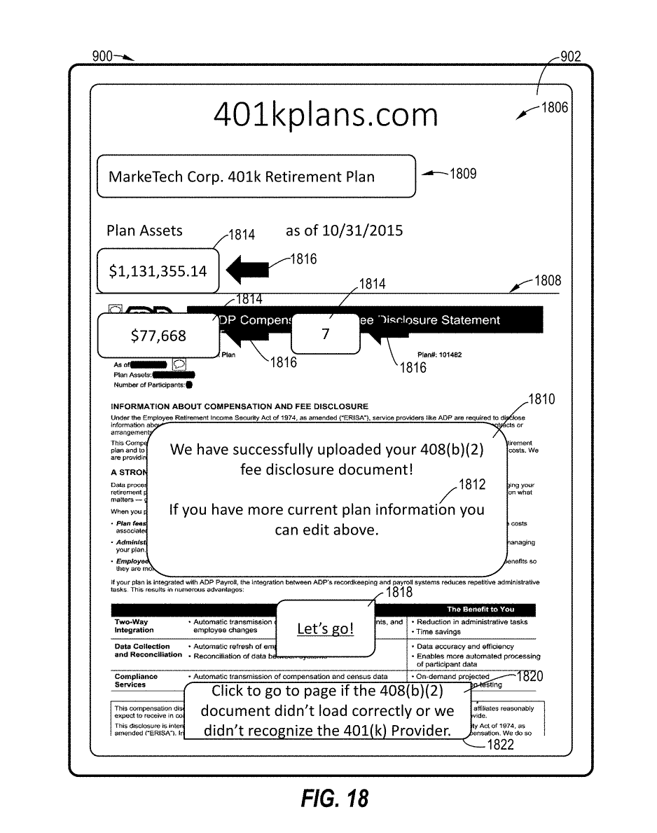

FIG. 18 shows the computing device 900 displaying a view 1806 that may be generated and/or displayed at, or otherwise in association with, steps for processing a 408(b)(2) form 30 (FIG. 3) after a user indicates that a 408(b)(2) document is to be reviewed or processed or analyzed by activating one or more graphical tools in the view 1606 (FIG. 16) and after the upload is successful and/or after a client confirms the plan information by activating one or more graphical tools in the view 1707 (FIG. 17).

Referring to FIG. 18, the view 1806 may include a representation 1808 (exact or otherwise) of an 408(b)(2) document that has been uploaded and is to be reviewed or processed or analyzed, and information 1809 indicating the plan with which the 408(b)(2) document is associated.

The view 1806 may further include a header or other information 1810 indicating that the upload of the 408(b)(2) document was successful, one or more prompt or other information 1812 indicating an opportunity to update information associated with the plan, one or more graphical tools 1814, which may be activated by the client to provide such updated information, one or more arrows or other indicators 1816 to provide guidance (and/or to indicate one or more active fields or one or more other active graphical tools) and one or more graphical tools 1818, which may be activated to confirm such information and/or to proceed.

If the upload was unsuccessful, the view 1806 may alternatively include a prompt or other information 1820 indicating that the upload of the 408(b)(2) document was unsuccessful, and one or more graphical tools 1822, which may be activated to proceed accordingly and/or to a next view.

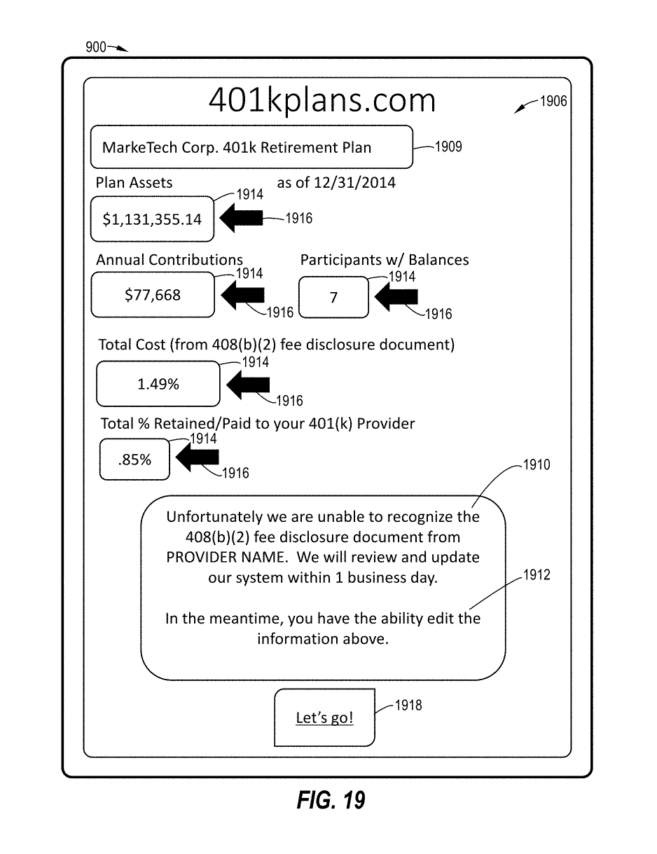

FIG. 19 shows the computing device 900 displaying a view 1906 that may be generated and/or displayed at, or otherwise in association with, a process for proceeding after an unsuccessful attempt to upload of a 408(b)(2) document, e.g., after activation of one or more graphical tools 1822 in the view 1806 (FIG. 18).

Referring to FIG. 19, the view 1906 may include information 1909 indicating the plan with which the 408(b)(2) document is associated, and information 1910 indicating that the upload of the 408(b)(2) document was unsuccessful. The view 1906 may further include one or more prompt or other information 1912 indicating an opportunity to update information associated with the plan, one or more graphical tools 1914, which may be activated by the user and/or client to provide such updated information, one or more arrows or other indicators 1916 to provide guidance (and/or to indicate one or more active fields or one or more other active graphical tools), and one or more graphical tools 1918, which may be activated to confirm such information and/or to proceed accordingly and/or to a next view.

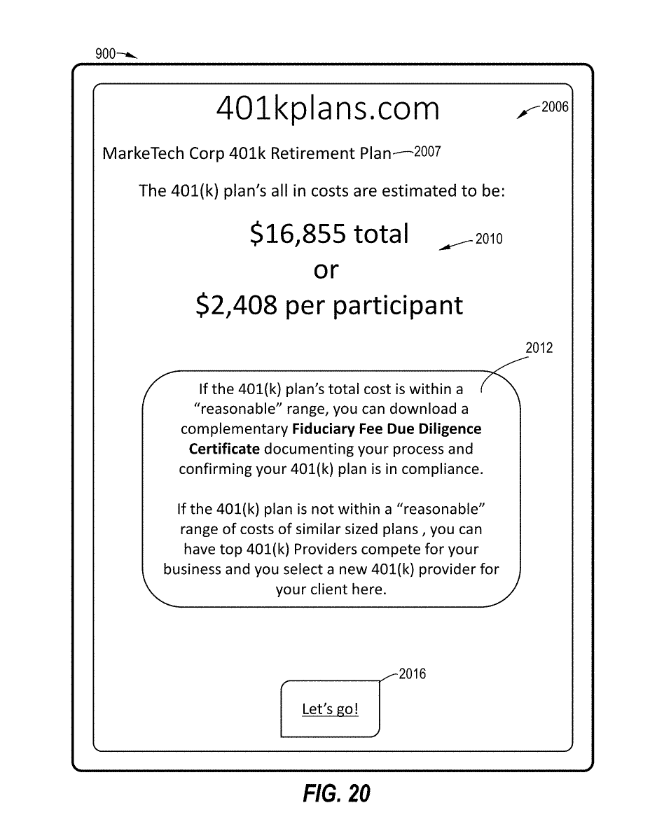

FIG. 20 shows the computing device 900 displaying a view 2006 that may be generated and/or displayed at, or otherwise in association with, a process for processing a 408(b)(2) form 30 (FIG. 3), e.g., after a successful upload of a 408(b)(2) document and activation of one or more graphical tools 1818 in the view 1806 (FIG. 18).

Referring to FIG. 20, the view 2006 may include a header or other information 2007 indicating the plan with which the 408(b)(2) document is associated, and information 2010 indicative of an estimate of one or more cost (total cost, cost per participant and/or other cost breakdown) of the plan. In at least some embodiments, the estimate of the one or more cost is based at least in part on the uploaded 408(b)(2) document. In at least some embodiments, the process includes parsing the uploaded 408(b)(2) document, extracting cost information from the parsed uploaded document and determining the one or more cost based at least in part on the extracted cost information.

The view 2006 may further include information 2012 regarding a next step in the process and one or more graphical tools 2016, which may be activated by a user to proceed.

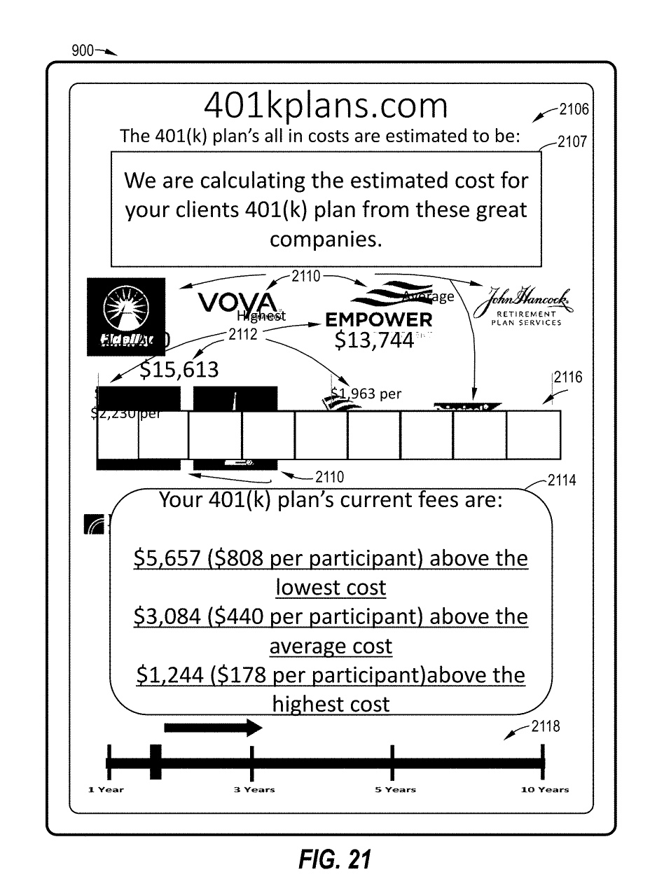

FIG. 21 shows the computing device 900 displaying a view 2106 that may be generated and/or displayed at, or otherwise in association with, a process for processing a 408(b)(2) form 30 (FIG. 3), e.g., after a successful upload of a 408(b)(2) document, determination of the estimated cost(s) 2010 (FIG. 20) and activation of one or more graphical tools 2016 in the view 2006 (FIG. 20).

Referring to FIG. 21, the view 2106 may include information that identifies the view and/or its location 2107 within the graphical user interface. The view may alternatively or may further include one or more logos or other information 2110 identifying one or more other providers that could provide the client with a 401(k) plan, and for each of the one or more other providers, information 2112 indicative of an estimate of a cost (total cost, cost per participant and/or other cost breakdown) for such a plan from such other provider. In at least some embodiments, such estimate is based at least in part on an uploaded 408(b)(2) document from such other provider. In at least some embodiments, the process includes parsing the uploaded 408(b)(2) document from such other provider, extracting cost information from the parsed uploaded document and determining the cost based at least in part on the extracted cost information.

The view 2106 may include information indicative of a comparison 2114 between the estimate of the cost of the plan from the current provider and one or more cost based at least in part on the estimate of the cost for one or more plans from one or more of the one or more other providers. The view 2106 may alternatively or further include a heat map 2116, a time line 2118 and/or other type of chart or other visualization based at least in part on the various estimates of costs to assist a user and/or client in making a decision regarding the 401(k) plan of the client (e.g., maintain the current plan from the current provider or select a new plan from a new provider).

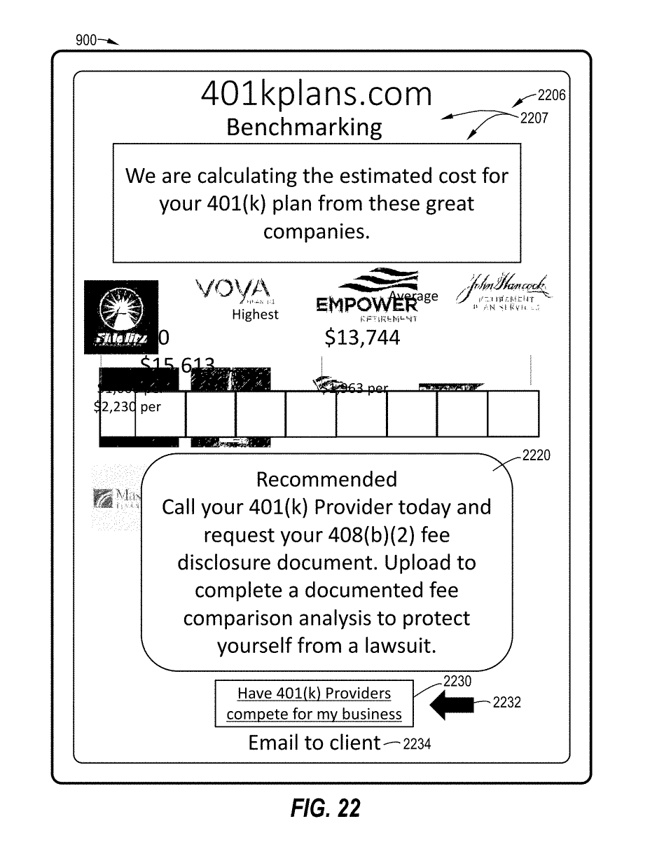

FIG. 22 shows the computing device 900 displaying a view 2206 that may be generated and/or displayed at, or otherwise in association with, the process 40 (FIG. 4) that may be performed if no 408(b)(2) document is uploaded or provided, e.g., after activation of one or more graphical tools 1616 in the view 1606 (FIG. 16).

Referring to FIG. 22, the view 2206 may include a header or other information that identifies the view and/or its location 2207 within the graphical user interface. The view may alternatively or may further include the one or more logos or other information identifying one or more other providers that could provide the client with a 401(k) plan, and for each of the one or more other providers, the information indicative of an estimate of a cost (total cost, cost per participant and/or other cost breakdown) for such a plan from such other provider.

The view 2206 may include a recommendation 2220 that the client call the current 401(k) provider to request a current 408(b)(2) fee disclosure document, and that the document be uploaded to allow analysis and comparison of costs.

The view 2206 may further include one or more graphical tools 2230, which may be activated to indicate a request that other 401(k) providers compete for the 401(k) business of the client and one or more arrows or other indicators 2232 to guide the user in regard to proceeding with the process (and/or to indicate one or more active fields or one or more other active graphical tools).

The view 2206 may include one or more graphical tools 2234, which may be activated by a user to request that a copy of the view 2206 (or portion(s) thereof) or information based at least in part thereon, be emailed or otherwise transmitted to a computing device of the client. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device.

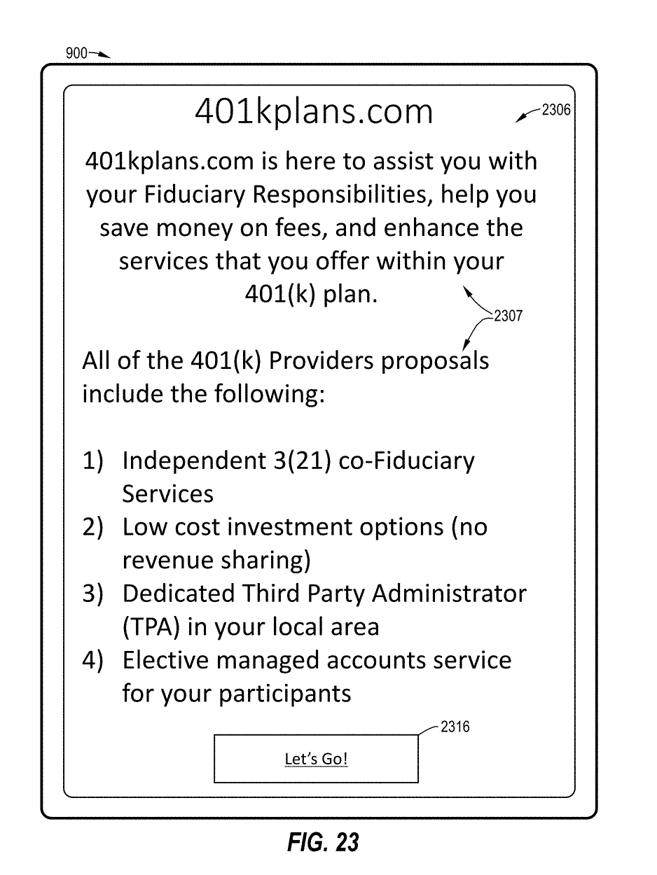

FIG. 23 shows the computing device 900 displaying a view 2306 that may be generated and/or displayed at, or otherwise in association with, the process 50 (FIG. 5) for shopping for a new provider.

Referring to FIG. 23, the view 2306 may include information 2307 in regard to one or portions of the process and/or system and/or features thereof. The view 2306 may alternatively or may further include one or more graphical tools 2316, which may be activated by a user to proceed.

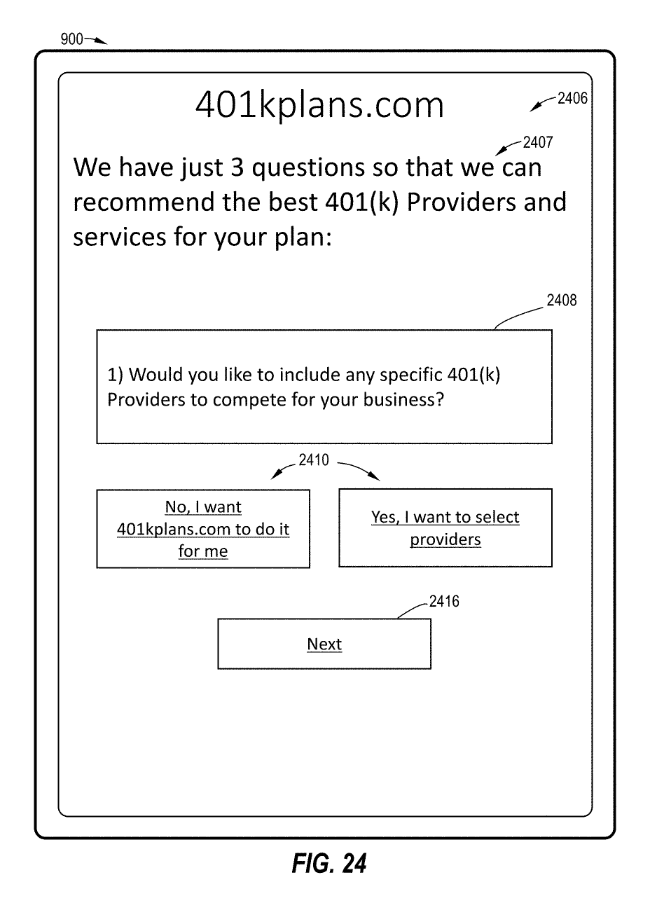

FIG. 24 shows the computing device 900 displaying a view 2406 that may be generated and/or displayed at, or otherwise in association with, the process 50 (FIG. 5) for shopping for a new provider.

Referring to FIG. 24, the view 2406 may include a header or other information that identifies the view and/or its location 2407 within the graphical user interface.

The view 2406 further includes one or more prompts 2408 or other instructions for the user to provide information in regard to shopping for a new provider, i.e., for the user to provide a response to a first one of three questions—whether the user would prefer to include any specific 401(k) providers in a competition to be the new provider. The view 2406 may further include one or more graphical tools 2410, which may be activated by a user to provide the requested information.

The view 2406 may further include one or more graphical tools 2416, which may be activated by the user to indicate a desire to navigate to another (e.g., next) view in the graphical user interface.

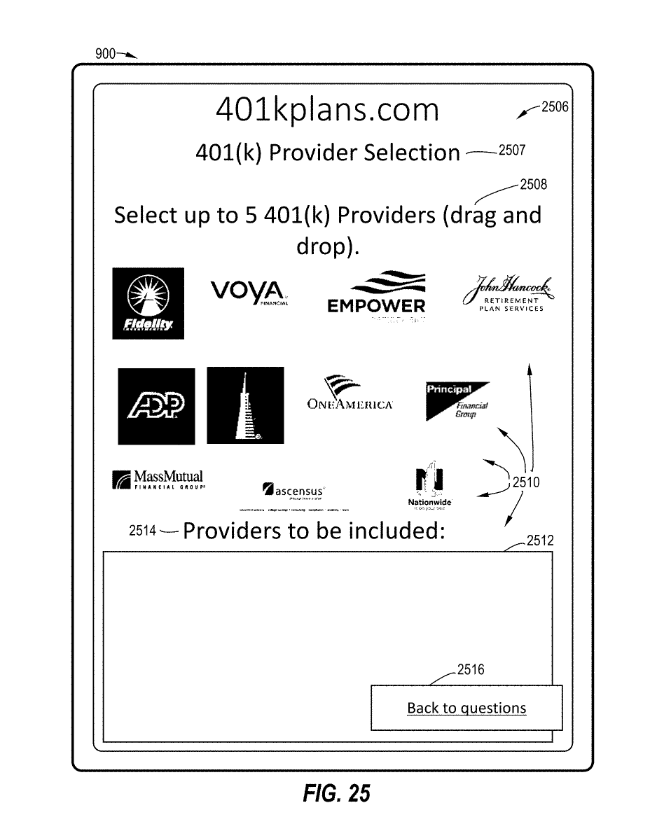

FIG. 25 shows the computing device 900 displaying a view 2506 that may be generated and/or displayed at, or otherwise in association with, the process 50 (FIG. 5) for shopping for a new provider, e.g., after activation of one or more graphical tools 2410 in the view 2406 (FIG. 24) to indicating a preference to select providers to be included in the competition to be the new provider.

Referring to FIG. 25, the view 2506 may include a header or other information that identifies the view and/or its location 2507 within the graphical user interface.

The view 2506 further includes one or more prompts 2508 or other instructions for the user in regard to shopping for a new provider, and one or more graphical tools 2510, which may be activated by a user to provide the requested information, i.e., information identifying the one or more providers the user would prefer to include in the competition to be the new provider. In at least some embodiments, the one or more graphical tools 2510 include a plurality of logos or other icons each associated with and identifying a respective provider and capable of being dragged (from a first region of the view) and dropped (in a second region of the view, which may be identified by border 2512 and/or a label 2514) to identify the respective provider as one of the providers that the user would prefer to include in the competition.

The view 2506 may further include one or more graphical tools 2516, which may be activated by the user to indicate a desire to navigate to another (e.g., next) view in the graphical user interface.

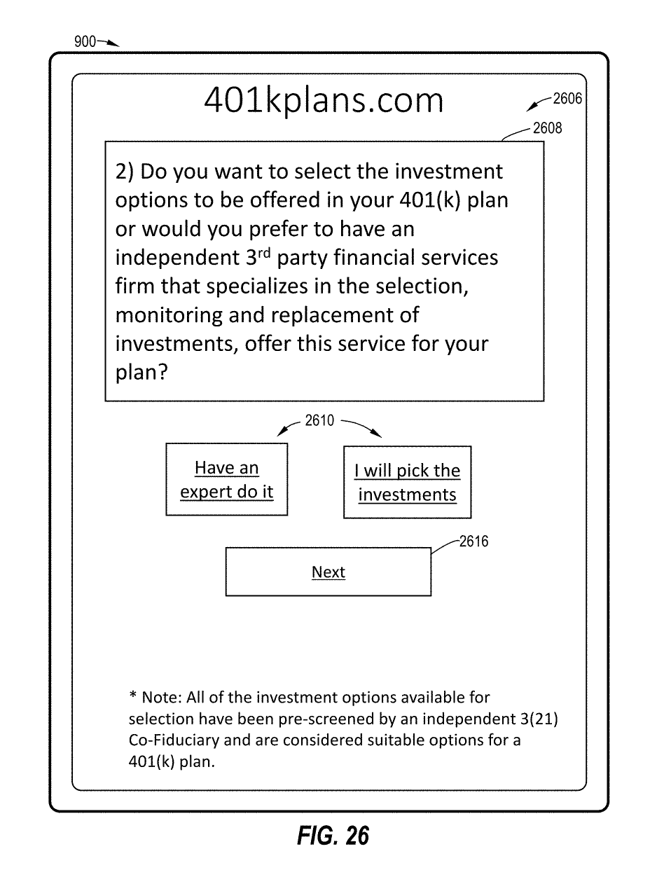

FIG. 26 shows the computing device 900 displaying a view 2606 that may be generated and/or displayed at, or otherwise in association with, the process 50 (FIG. 5) for shopping for a new provider, e.g., after activation of one or more graphical tools 2516 in the view 2506 (FIG. 25).

Referring to FIG. 26, the view 2606 may include one or more prompts 2608 or other instructions for the user to provide information in regard to shopping for a new provider, i.e., for the user to provide a response to a second one of three questions,—whether the user would prefer to select the investment options to be offered in the 401(k) plan or have another entity (e.g., an independent third party financial services firm that specializes in the selection, monitoring and replacement of investments) select the investment options to be offered. The view 2606 may further include one or more graphical tools 2610, which may be activated by a user to provide the requested information.

The view 2606 may further include one or more graphical tools 2616, which may be activated by the user to indicate a desire to navigate to another (e.g., next) view in the graphical user interface.

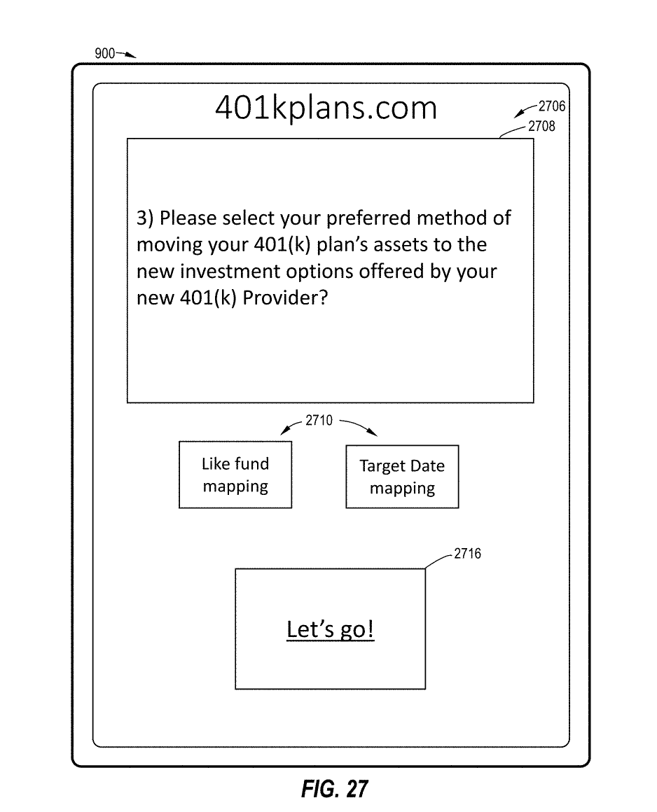

FIG. 27 shows the computing device 900 displaying a view 2706 that may be generated and/or displayed at, or otherwise in association with, the process 50 (FIG. 5) for shopping for a new provider, e.g., after activation of one or more graphical tools 2616 in the view 2606 (FIG. 26).

Referring to FIG. 27, the view 2706 may include one or more prompts 2708 or other instructions for the user to provide information in regard to shopping for a new provider, i.e., for the user to provide a response to a third one of three questions—how the user would prefer to have the plans assets allocated when moved to the new plan, e.g., target date mapping or like fund mapping, and one or more graphical tools 2710, which may be activated by a user to provide the requested information.

The view 2706 may further include one or more graphical tools 2716, which may be activated by the user to indicate a desire to navigate to another (e.g., next) view in the graphical user interface.

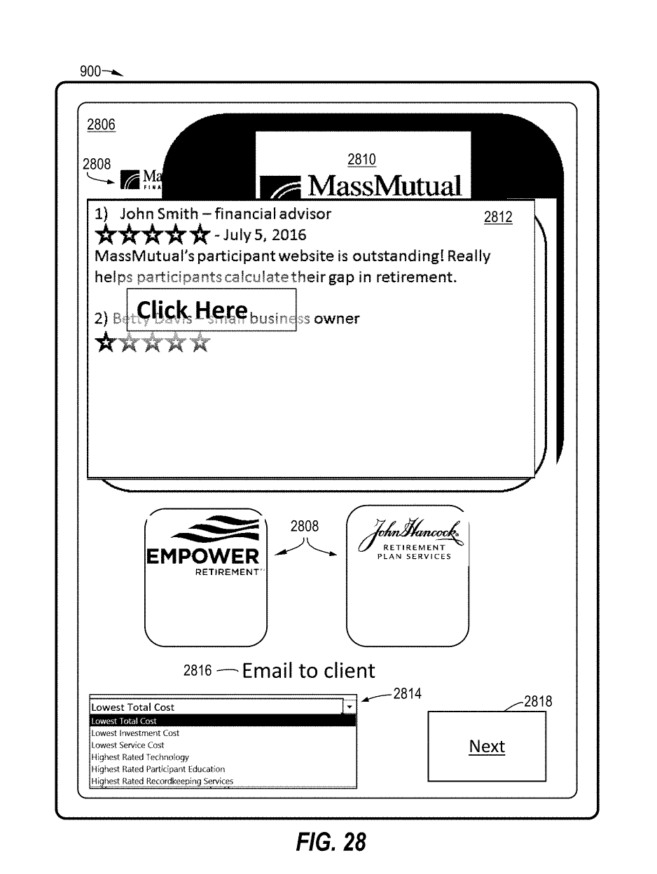

FIG. 28 shows the computing device 900 displaying a view 2806 that may be generated and/or displayed at, or otherwise in association with, the process 50 (FIG. 5) and/or process 60 (FIG. 60) for shopping for a new provider, e.g., after activation of one or more graphical tools 2716 in the view 2706 (FIG. 27).

Referring to FIG. 28, the view may include one or more logos or other information identifying one or more providers that have been selected to compete for the 401(k) business of the client.

The view 2806 may further include one or more graphical tools 2808, which may be activated by a user (e.g., by a finger tap or other gesture and/or a mouse click) to request information regarding one or more of the providers and/or a plan offered thereby.

In at least some embodiments, each of the one or more graphical tools 2808 comprises a button that identifies and/or is otherwise associated with a respective one of the providers and is activatable by a user (e.g., by a finger tap or other gesture and/or a mouse click) to request information regarding the respective provider and/or a plan offered by the respective provider. The information may have any form and may be provided in any manner. In some embodiments, the information may be displayed within a pop up window that opens after the button is activated. In the illustrated embodiment, the user has activated a button associated with one of the providers (identified by logo 2810), which has resulted in opening of a pop up window 2812 that displays one or more reviews or other information regarding or otherwise associated with the provider.

The view 2806 may further include one or more graphical tools 2814, which may be activated by a user to indicate one or more criteria (lowest total cost, lowest investment cost, lowest service cost, highest rated technology, highest rated participant education, highest rated record keeping services and/or any other criteria) based at least in part on which the user requests to have the providers ranked and/or otherwise compared. In the illustrated embodiment, the one or more graphical tools 2814 comprises a drop-down menu and the user has activated the drop down menu and selected the criteria of lowest total cost.

The view 2806 may further include one or more graphical tools 2816, which may be activated by a user to request that a copy of the view 2806 (or portion(s) thereof) or information based at least in part thereon, be emailed or otherwise transmitted to a computing device of the client. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device.

The view 2806 may further include one or more graphical tools 2818, which may be activated by the user to indicate a desire to navigate to another (e.g., next) view in the graphical user interface.

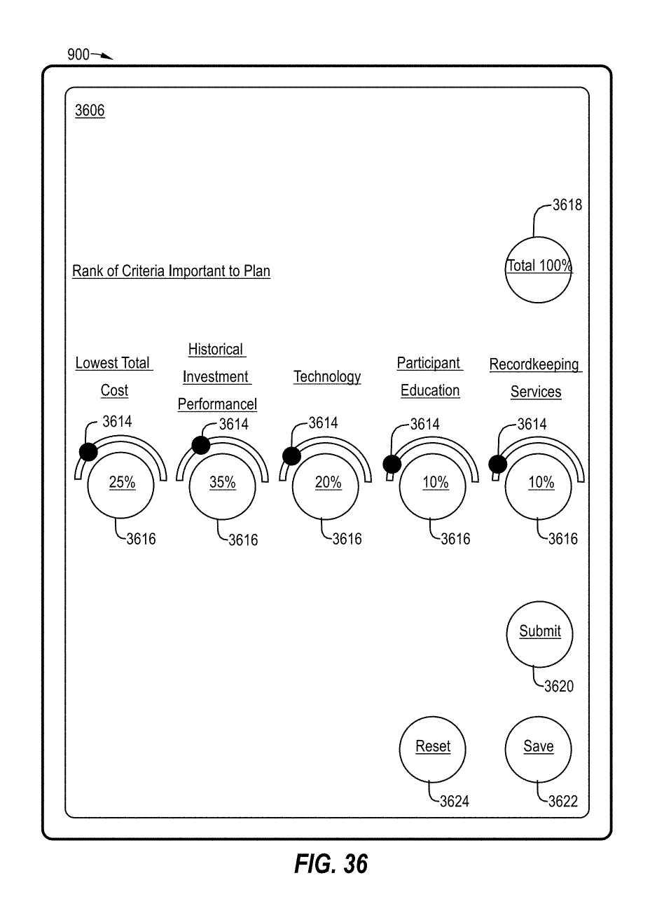

FIG. 36 shows the computing device 900 displaying a view 3606 that that includes an alternative to the graphical tool 2814 in the view 2806 (FIG. 28) and generated and/or displayed at, or otherwise in association with, the process 50 (FIG. 5) and/or process 60 (FIG. 60) for shopping for a new provider, e.g., after activation of one or more graphical tools 2716 in the view 2706 (FIG. 27).

Referring to FIG. 36, the view 3606 may list or otherwise display a plurality of criteria based on which the one or more providers may be ranged or otherwise compared.

In at least some embodiments, the view 3606 may further include one or more graphical tools 3614, each of which may be associated with a respective one of the plurality of criteria and activatable by a user to indicate a weight or other relative importance of the respective criteria compared the other criteria displayed in the view 3606. In the illustrated embodiment, the one or more graphical tools 3614 comprise sliders.

The view 3606 may further include one or more indication 3616, each of which may be associated with a respective one of the plurality of criteria and indicate a weight or other relative importance that the user has allocated to or otherwise indicated for the respective criteria.

In the illustrated embodiment, the user has activated the graphical tools 3614 to indicate that a first criteria (lowest total coast) has a weight or other relative importance of 25%, a second criteria (historical investment performance) has a weight or other relative importance of 35%, a third criteria (technology) has a weight or other relative importance of 20%, a fourth criteria (participant education) has a weight or other relative importance of 10%, and a fifth criteria (recordkeeping services) has a weight or other relative importance of 10%.

The view 3606 may further provide an indication 3618 as to whether the user has allocated all the available weight, e.g., 100%.

The view 3606 may further include a graphical tool 3620, which may be activated by a user to submit the weights or other allocation of relative importance for use in a comparison. The method may further include determining a ranking and/or other comparison based at least in part on the weights or other allocation of relative importance.

The view 3606 may include one or more graphical tools 3622, 3624 which may be activated by a user to request that the weights or other measure of relative importance be saved and/or reset.

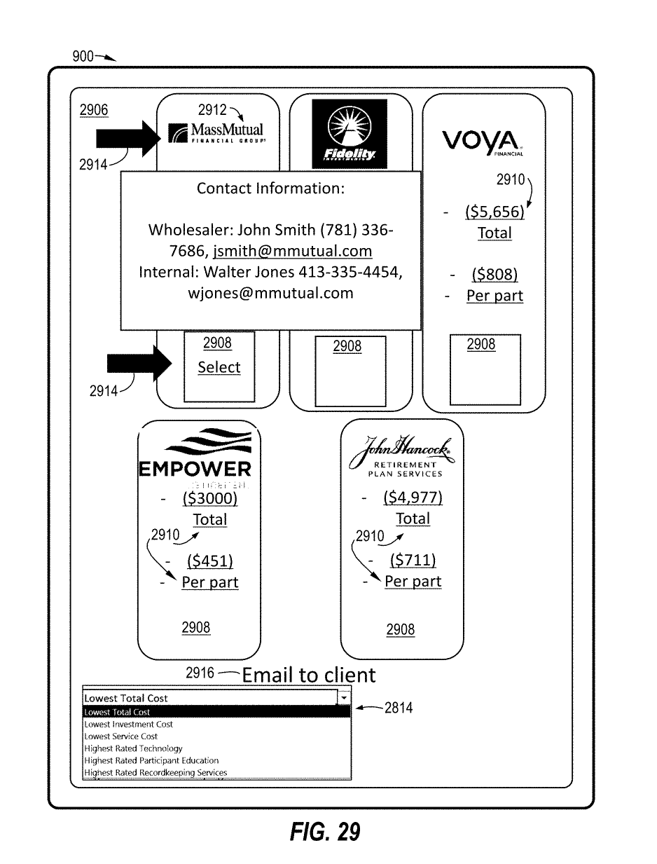

FIG. 29 shows the computing device 900 displaying a view 2906 that may be generated and/or displayed at, or otherwise in association with, the process 60 (FIG. 60) for shopping for a new provider, e.g., after activation of one or more graphical tools 2818 in the view 2806 (FIG. 28).

Referring to FIG. 29, the view may include one or more logos or other information identifying the one or more providers that have been selected to compete for the 401(k) business of the client.

The view 2906 may further include one or more graphical tools 2908, which may be activated by a user (e.g., by a finger tap or other gesture and/or a mouse click) to select one of the providers to provide the plan for the client. In at least some embodiments, each of the one or more graphical tools 2908 comprises a button that identifies and/or is otherwise associated with a respective one of the providers and is activatable by a user (e.g., by a finger tap or other gesture and/or a mouse click) to select the respective provider to provide the plan for the client.

The view 2906 may further include a ranking or other comparison of the providers (comparison information) that may be based at least in part on the selected criteria.

In the illustrated embodiment, the user has activated a button associated with one of the providers (identified by logo 2912) to indicate selection of that provider, which may further result in opening of a pop up window that displays a contact associated with the provider and contact information for the contact.

The view may further include one or more arrows or other indicators 2914 to guide the user in making the selection (and/or to indicate one or more active fields or one or more other active graphical tools).

The view 2906 may further include one or more graphical tools 2916, which may be activated by a user to request that a copy of the view 2906 (or portion(s) thereof) or information based at least in part thereon, be emailed or otherwise transmitted to a computing device of the client. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device.

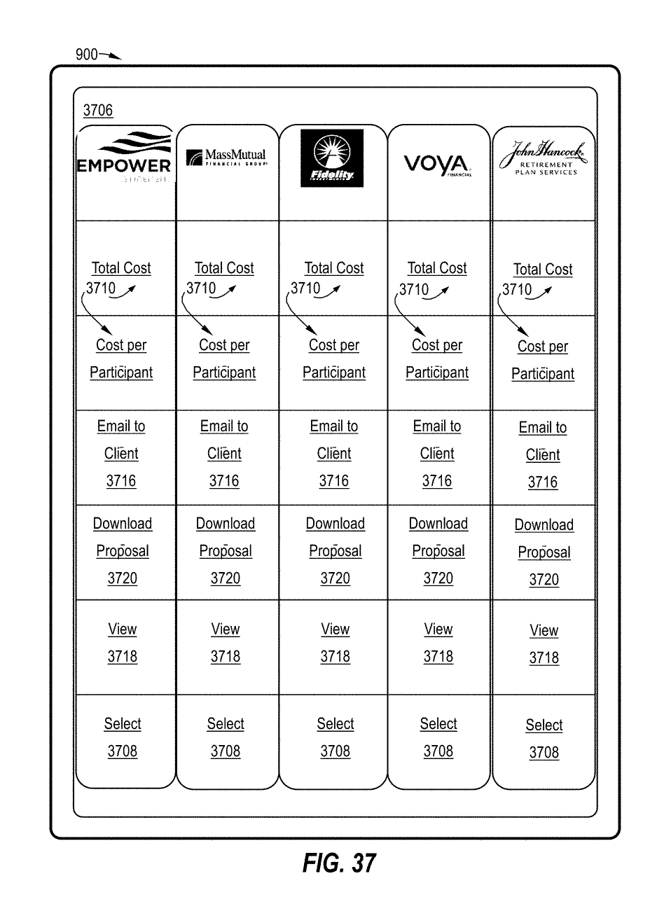

FIG. 37 shows the computing device 900 displaying a view 3706 that may be an alternative to the view 2906 (FIG. 29) and may be generated and/or displayed at, or otherwise in association with, the process 60 (FIG. 60) for shopping for a new provider, e.g., after activation of one or more graphical tools 2818 in the view 2806 (FIG. 28).

Referring to FIG. 37, the view may include one or more logos or other information identifying the one or more providers that have been selected to compete for the 401(k) business of the client.

The view 3706 may further include a ranking or other comparison 3710 of the providers (comparison information) that may be based at least in part on the selected criteria.

The view 3706 may further include one or more graphical tools 3708, each of which may be associated with a respective one of the one or more providers and activatable by a user to select the respective provider to provide the plan for the client. In at least some embodiments, each of the one or more graphical tools 3708 comprises a button that identifies and/or is otherwise associated with a respective one of the providers and is activatable by a user (e.g., by a finger tap or other gesture and/or a mouse click) to select the respective provider to provide the plan for the client.

The view 3706 may further include one or more graphical tools 3716, each of which may be associated with a respective one of the one or more providers and activatable by a user to request that a copy of a proposal and/or other information associated with the respective provider (and/or a copy of the view or portion(s) thereof) be emailed or otherwise transmitted to a computing device of the client. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device.

The view 3706 may further include one or more graphical tools 3718, each of which may be associated with a respective one of the one or more providers and activatable by a user to request that a proposal and/or other information associated with the respective provider be displayed in the view 3606.

The view 3706 may further include one or more graphical tools 3720, each of which may be associated with a respective one of the one or more providers and activatable by a user to request that a proposal and/or other information associated with the respective provider be downloaded or otherwise generated and provided.

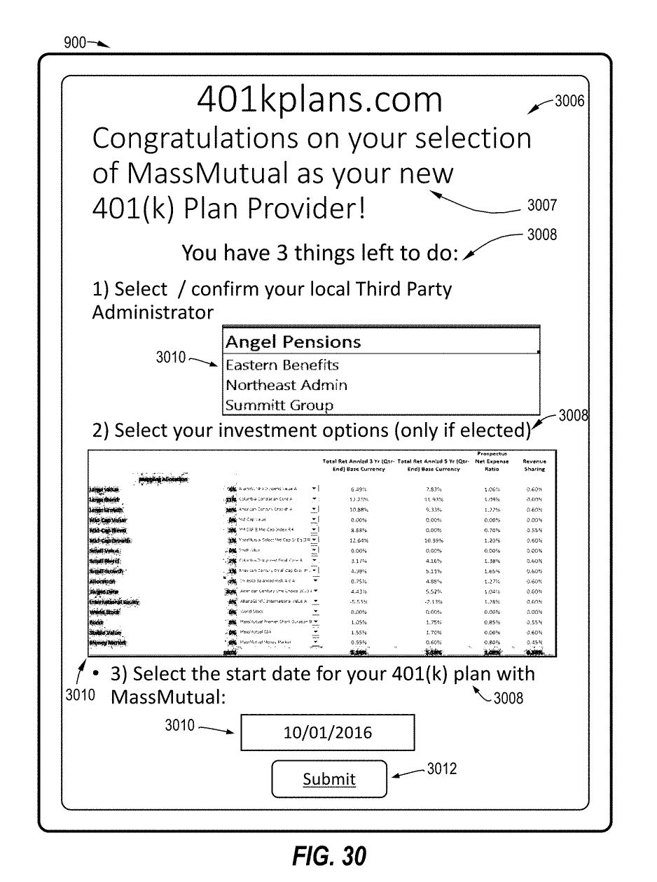

FIG. 30 shows the computing device 900 displaying a view 3006 that may be generated and/or displayed at, or otherwise in association with, the process 60 (FIG. 60) for shopping for a new provider, e.g., after activation of one or more graphical tools 2908 in the view 2906 (FIG. 29).

Referring to FIG. 30, the view 3006 includes a header or other information 3007 that confirms or otherwise indicates the selection that was made.

The view 3006 further includes one or more prompts or other instructions 3008 for the user to select from various options (in regard to the plan) or otherwise provide information (in regard to the plan), and one or more graphical tools 3010, which may be activated by a user to provide the requested information.

The view 3006 may further include one or more graphical tools 3012, which may be activated by the user to submit the requested information and/or to navigate to another (e.g., next) view in the graphical user interface.

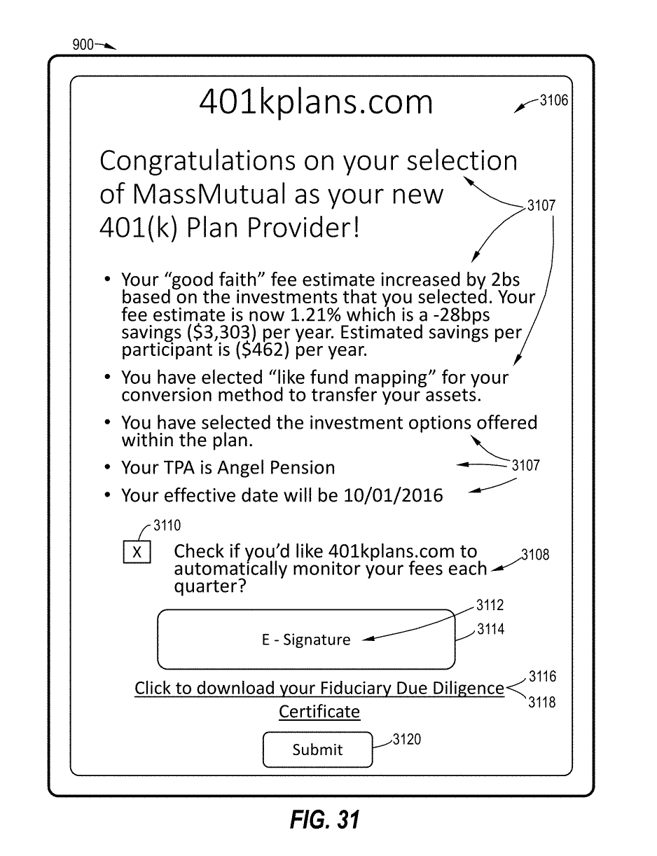

FIG. 31 shows the computing device 900 displaying a view 3106 that may be generated and/or displayed at, or otherwise in association with, the process 60 (FIG. 60) for shopping for a new provider, e.g., after activation of one or more graphical tools 3012 in the view 3006 (FIG. 30).

Referring to FIG. 31, the view 3106 includes information 3107 showing or otherwise indicating one or more of the one or more selections that were made, e.g., to allow the user to confirm or otherwise acknowledge that the selections were properly received and/or recorded.

The view 3106 may further include one or more prompts or other instructions 3108 for the user to indicate whether the user would like to have fees (charged by the provider in regard to the plan and/or one or more events or other aspects in regard to the plan) monitored automatically, and one or more graphical tools 3110, which may be activated by a user to provide the requested information.

The view 3106 may further include one or more prompts or other instructions 3112 for the user to confirm or otherwise acknowledge (e.g., by providing an electronic signature) that the selections were properly received and/or recorded, and one or more graphical tools 3114, which may be activated by a user to provide the requested information (e.g., an electronic signature).

The view 3106 may further include one or more prompts or other instructions 3116 for the user to request downloading or otherwise generating a fiduciary due diligence certificate or other certificate, which may certify the analysis of the current plan, the comparison of the plans and/or the selection of the new plan, and one or more graphical tools 3118, which may be activated by a user to request such. In some embodiments, the certificate certifies performance of steps required under a regulatory scheme for due diligence in choosing plans among available plans.

The view 3106 may further include one or more graphical tools 3120, which may be activated by the user to submit the requested information and/or to navigate to another (e.g., next) view in the graphical user interface.

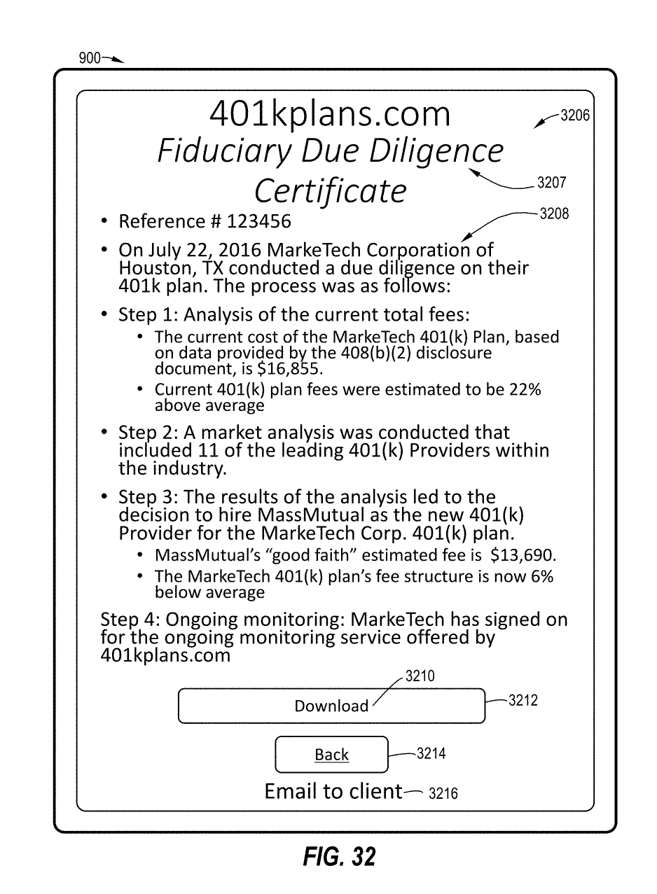

FIG. 32 shows the computing device 900 displaying a view 3206 that may be generated and/or displayed at, or otherwise in association with, the process 60 (FIG. 60) for shopping for a new provider, e.g., after activation of one or more graphical tools 3120 in the view 3106 (FIG. 31).

Referring to FIG. 32, the view 3206 includes a header or other information 3207 that identifies the view as a fiduciary due diligence certificate (or other certificate).

The view 3206 further includes information 3208 showing or otherwise indicating results or other details of: (1) an analysis that was performed in regard to a current plan (e.g., current total cost (or one or more other selection criteria) associated with the current plan and/or a comparison thereof to estimates of total costs (or one or more other selection criteria) that would be associated with other available plans), (2) an analysis that was performed in regard to other available plans, (3) one or more result of the analysis (e.g., current total cost (or one or more other selection criteria) associated with the selected investment plan and/or a comparison thereof to estimates of total costs (or one or more other selection criteria) that would be associated with other available plans) and a selection made, based at least in part thereon, in regard to a new investment plan, (4) whether ongoing monitoring will be performed in regard to the investment plan. In at least some embodiments, the selection criteria comprises a cost metric.

The view 3206 may further include one or more prompts or other instructions 3210 for the user to request downloading or otherwise outputting of a copy of the fiduciary due diligence certificate (or other certificate) or other record of the information therein (e.g., one or more analysis, one or more comparison, one or more selection) (or one or more portions thereof) or information based at least in part thereon. The view 3206 may further include one or more graphical tools 3212, which may be activated by a user to request such.

The view 3206 may further include one or more graphical tools 3214, which may be activated by the user to submit the requested information and/or to navigate to another (e.g., previous) view in the graphical user interface.

The view 3206 may further include one or more graphical tools 3216, which may be activated by a user to request that a copy of the view 3206 and/or certificate (or portion(s) thereof) or information based at least in part thereon, be emailed or otherwise transmitted to a computing device of the client.

As stated above, in at least some embodiments, any view disclosed herein, or one or more portions thereof, may be intended for a representative of the client, rather than or in addition to the user. In some embodiments, any such view, or one or more portions thereof, may be generated and/or displayed on a computing device of the client, rather than or in addition to the computing device 900. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device. In some embodiments, the method may further include responding to the reply or other information from the client, as if the reply or other information was provided by the user and/or in any other manner as may be appropriate.

Thus, in at least some embodiments, any one or more of views 1706, 1806, 1906, 2006, 2106, 2206, 2306, 2406, 2506, 2606, 2706, 2806, 2906, 3006, 3106, 3206, 3606, 3706 and/or any other views, or one or more portions thereof, may be intended for a representative of the client, rather than or in addition to the user. In some embodiments, any one or more of views 1706, 1806, 1906, 2006, 2106, 2206, 2306, 2406, 2506, 2606, 2706, 2806, 2906, 3006, 3106, 3206, 3606, 3706 and/or any other views, or one or more portions thereof, may be generated and/or displayed on a computing device of the client, rather than or in addition to the computing device 900. In some embodiments, the method may further include receiving a reply or other information from the client in response, at least in part, thereto. In some embodiments, the reply or other information may be transmitted by the client device in response to activation, by the client, of one or more graphical tools in a graphical user interface provided to the client by the client device.

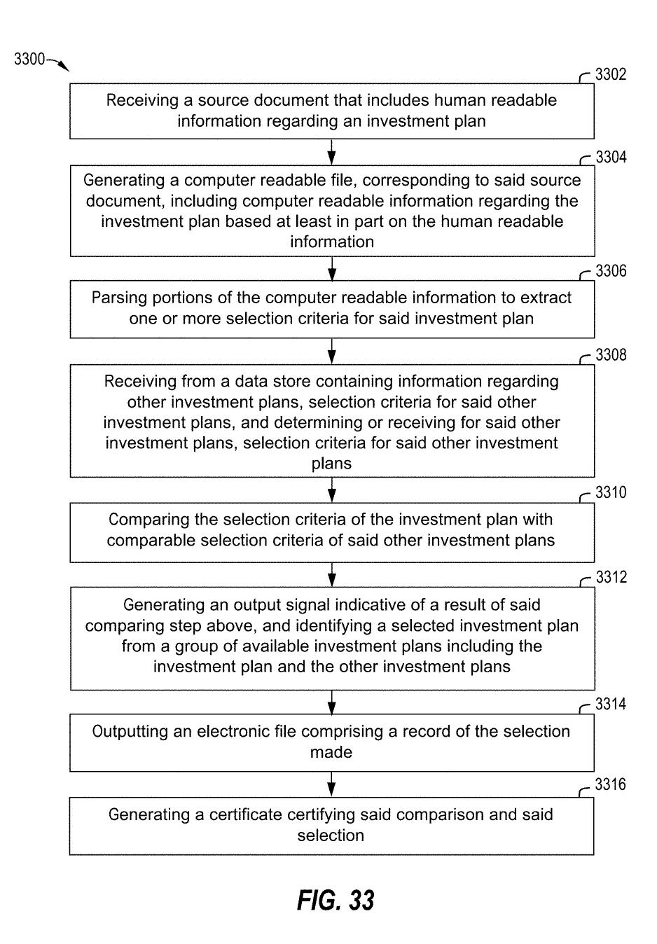

FIG. 33 is a flowchart 3300 of a method in accordance with some embodiments.

In at least some embodiments, one or more portions of the method may be used without one or more other portions of the method. For that matter, in at least some embodiments, one or more portions of any method disclosed herein may be used without one or more other portions of such method.

In at least some embodiments, the method (or one or more portion(s) thereof) may be performed using one or more portions of one or more other methods disclosed herein. For that matter, in at least some embodiments, any method (or one or more portions thereof) disclosed herein may be performed using one or more portions of one or more other methods disclosed herein.

In at least some embodiments, the method (or one or more portion(s) thereof) may be performed in performance of one or more portions of one or more other methods disclosed herein. For that matter, in at least some embodiments, any method (or one or more portions thereof) disclosed herein may be performed in performance of one or more portions of one or more other methods disclosed herein.

In at least some embodiments, the method (or one or more portion(s) thereof) may be performed by the device 900.

Referring now to FIG. 33, at 3302, the method may include receiving a source document that includes human readable information regarding an investment plan. In at least some embodiments, the source document may be received in any manner(s) from any source(s) (internal and/or external).

In at least some embodiments, the receiving of a source document may be performed at or otherwise in association with one or more portions of FIG. 1 (e.g., after an indication that a 408(b)(2) document is to be reviewed or processed or analyzed), FIG. 3 (e.g., before the 408(b)(2) document is reviewed or processed or analyzed), FIG. 16 (e.g., after a user activates one or more graphical tools 1616) and/or FIG. 18 (e.g., prior to display of information 1810 indicating that an upload of the 408(b)(2) document was successful).

At 3304, the method may further include generating a computer readable file, corresponding to said source document, including computer readable information regarding the investment plan based at least in part on the human readable information. In at least some embodiments, the generating of the computer readable information may be performed in any manner(s).

At 3306, the method may further include parsing portions of the computer readable information to extract one or more selection criteria for said investment plan. In at least some embodiments, the parsing and may be performed in any manner(s) and the extracted selection criteria may have any form(s). In some embodiments, the extracted selection criteria may comprise total cost, investment cost and/or service cost.

In at least some embodiments, the parsing of portions of the computer readable information may be performed at or otherwise in association with one or more portions of FIG. 3 (e.g., in determining costs associated with client's current plan), FIG. 19 (e.g., in determining costs associated with client's current plan) and/or FIG. 20 (e.g., in determining costs associated with client's current plan).

At 3308, the method may further include receiving from a data store containing information regarding other investment plans, selection criteria for said other investment plans, and determining or receiving for said other investment plans, selection criteria for said other investment plans. In at least some embodiments, the information may have any form(s) and may be received in any manner(s). The data store may comprise any type(s) of data store(s) internal and/or external.

In at least some embodiments, the receiving and the determining or receiving may be performed at or otherwise in association with one or more portions of FIG. 3 (e.g., prior to comparing costs associated with client's current plan to costs associated with other plans and/or determining if the current costs are in a “reasonable” range), FIG. 20 (e.g., prior to comparing costs associated with client's current plan to costs associated with other plans and/or determining if the current costs are in a “reasonable” range) and/or FIG. 21 (e.g., prior to comparing costs associated with client's current plan to costs associated with other plans and/or determining if the current costs are in a “reasonable” range).

At 3310, the method may further include comparing the selection criteria of the investment plan with comparable selection criteria of said other investment plans. In at least some embodiments, comparing may be performed in any manner(s) and may have any form(s).

In at least some embodiments, the receiving and the determining or receiving may be performed at or otherwise in association with one or more portions of FIG. 3 (e.g., in comparing costs associated with client's current plan to costs associated with other plans and/or determining if the current costs are in a “reasonable” range), FIG. 20 (e.g., in comparing costs associated with client's current plan to costs associated with other plans and/or determining if the current costs are in a “reasonable” range) and/or FIG. 21 (e.g., in comparing costs associated with client's current plan to costs associated with other plans and/or determining if the current costs are in a “reasonable” range).

At 3312, the method may further include generating an output signal indicative of a result of said comparing step above, and identifying a selected investment plan from a group of available investment plans including the investment plan and the other investment plans. In at least some embodiments, the generating an output signal may be performed in any manner(s) and the output signal indicative of a result of said comparing step may have any form(s).

In at least some embodiments, the generating an output signal indicative of a result of said comparing step may be performed at or otherwise in association with one or more portions of FIG. 3 (e.g., comparing costs associated with client's current plan to costs associated with other plans and/or determining if the current costs are in a “reasonable” range), FIG. 20 (e.g., comparing costs associated with client's current plan to costs associated with other plans and/or determining if the current costs are in a “reasonable” range) and/or FIG. 21 (e.g., comparing costs associated with client's current plan to costs associated with other plans and/or determining if the current costs are in a “reasonable” range).

In at least some embodiments, the output signal indicative of a result of said comparing step may comprise information that is the same as and/or similar to at least some of the information shown in FIG. 20 and/or FIG. 21. In at least some embodiments, the output signal indicative of a result of said comparing step may have a form that is the same as and/or similar to at least some portions of the view shown in FIG. 20 and/or FIG. 21.

In at least some embodiments, the identifying a selected investment plan may comprise receiving an indication of an investment plan selected (e.g., via activation of one or more graphical tools) by a user and/or client and identifying the investment plan selected by the user and/or client based at least in part on the indication.

In at least some embodiments, the identifying a selected investment plan may be performed at or otherwise in association with one or more portions of FIG. 6 (e.g., receiving an indication of a user's selection after prompting the client to select one of the providers), FIG. 29 (e.g., receiving an indication that a user has activated a graphical tool associated with one of the providers to indicate selection of an investment plan offered by that provider) and/or FIG. 37.

At 3314, the method may further include outputting an electronic file comprising a record of the selection made. In at least some embodiments, the outputting an electronic file may be performed in any manner(s) internal and/or external and the electronic file nay have any form(s). In at least some embodiments, the outputting an electronic file may be performed at or otherwise in association with one or more portions of FIG. 30, FIG. 31 and/or FIG. 32. In at least some embodiments, the record of the selection made may comprise information that is the same as and/or similar to at least some of the information shown in FIG. 30, FIG. 31 and/or FIG. 32.

At 3316, the method may further include generating a certificate certifying said comparison and said selection. In at least some embodiments, the certificate may have any form(s) and may be generated in any manner(s). In at least some embodiments, the generating a certificate certifying said comparison and said selection may be performed at or otherwise in association with one or more portions of FIG. 32. In at least some embodiments, the certificate may comprise information that is the same as and/or similar to at least some of the information shown in FIG. 32. In at least some embodiments, the certificate has a form that is the same as and/or similar to a form shown in FIG. 32.

In at least some embodiments, the method includes generating a record of one or more characteristics of the plan. In at least some embodiments, the generating a record of one or more characteristics of the plan may be performed in any manner(s) and the record nay have any form(s). In at least some embodiments, the generating a record of one or more characteristics of the plan may be performed at or otherwise in association with one or more portions of FIG. 29, FIG. 30, FIG. 31 and/or FIG. 32. In at least some embodiments, the record of one or more characteristics of the plan may comprise information that is the same as and/or similar to at least some of the information shown in FIG. 29, FIG. 30, FIG. 31 and/or FIG. 32.

In at least some embodiments, the selected investment plan is a 401k plan.

In at least some embodiments, the selection criteria include a cost metric.

In at least some embodiments, the generating said certificate comprises executing in said processor one or more steps required under a regulatory scheme for due diligence in choosing plans among available plans.

In at least some embodiments, the method may further comprise receiving, by a processor, a plurality of source documents each associated with a respective one of the plurality of other investment plans and including selection criteria for the respective one of the plurality of other investment plans.

In at least some embodiments, the method may further comprise, for each of the plurality of source documents, generating, by a processor, a computer readable file, corresponding to said source document, including computer readable information regarding the investment plan based at least in part on the human readable information; and parsing, by said processor, portions of the computer readable information to extract one or more selection criteria for said investment plan.

In at least some embodiments, the cost information and/or other selection criteria in one of the plurality of source documents may have a positioning, a format and/or a labeling scheme that is different than a positioning, a format and/or labeling scheme, respectively, of the cost information and/or other selection criteria in another of the source documents. Thus, in at least some embodiments, a first source document may include first cost information having first positioning within the document, with first formatting of the first cost information and first labelling of the first cost information corresponding thereto. A second source document may include second cost information having second positioning within the document, with second formatting of the second cost information and second labelling of the second cost information corresponding thereto, where the second positioning, the second formatting and/or the second labelling is different than the first positioning, the first formatting and/or the first labelling, respectively.

In accordance with at least some embodiments, the method includes parsing the first source document and extracting the first cost information therefrom, parsing the second source document and extracting the second cost information therefrom, harmonizing the first cost information and the second cost information, and comparing the harmonized first cost information and second cost information. As used herein, harmonizing means determining whether there is a difference in format, and if there is, converting the format of at least one so as to result in a common format that allows comparison.

In at least some embodiments, the cost information and/or other selection criteria in each one of the plurality of source documents may have a positioning, a format and/or a labeling scheme that is different than a positioning, a format and/or labeling scheme, respectively, of the cost information and/or other selection criteria in each (or at least a plurality) of the others of the source documents.

Thus, a third source document may include third cost information having third positioning within the document, with third formatting of the third cost information and third labelling of the third cost information corresponding thereto, where the third positioning, third formatting and third labelling are different than the first positioning, first formatting and/or first labelling, respectively, and/or different than the second positioning, the second formatting and/or the second labelling, respectively. And so on.

The method may further include parsing the third source document and extracting the third cost information therefrom, harmonizing the first cost information, the second cost information and the third cost information, and comparing the harmonized first cost information, second cost information and third information. And so on.

In at least some embodiments, each of a plurality of source documents may be a 408(b)(2) document that is associated with a respective 401 K plan and discloses all direct and indirect compensation that a respective provider of the plan receives, or will receive from, a client that uses such plan.

In at least some embodiments, the method permits automated parsing and processing of form documentation and data, e.g., as in a 408(b)(2) document and/o similar documents. In at least some embodiments, the method may be used by a marketplace. In at least some embodiments, the method further comprises establishing the online marketplace.

In at least some embodiments, the method may further include providing a dashboard view in a graphical user interface. In at least some embodiments, the dashboard view may include information reporting all advisor activity, market data trends and/or investment manager reporting.

In at least some embodiments, the method may further include providing one or more graphical tools (in a graphical user interface) or other type(s) of tools that may be activated by an advisor and/or other user to control compensation of an advisor, at least in part. In at least some embodiments, the method may include one or more tools that may be activated by a user to define the compensation of the advisor based at least in part on plan size. In at least some embodiments, the method may further include providing aggregate compensation market data as a function of plan size, service model and/or other criteria.

In at least some embodiments, the method may further include providing one or more graphical tools that may be activated by an advisor and/or other user to pre-select or otherwise indicate one or more preferred providers and/or one or more preferred investment options. In at least some embodiments, the method may further include providing one or more graphical tools that may be activated by an advisor and/or other user to make changes to one or more of the indications.

In at least some embodiments, the method may further include providing one or more graphical tools that may be activated by an advisor and/or other user to indicate one or more preferred providers and/or one or more preferred investment options. In at least some embodiments, the method may further include providing one or more graphical tools that may be activated by an advisor and/or other user to make changes to one or more of the indications.

In at least some embodiments, the method may further include providing one or more graphical tools, which may be activated by an advisor and/or other user to indicate one or more criteria (lowest total cost, lowest investment cost, lowest service cost, highest rated technology, highest rated participant education, highest rated record keeping services and/or any other criteria) based at least in part on which the user requests to have the providers ranked and/or otherwise compared. In at least some embodiments, lowest total cost may comprise lowest total cost for a given plan size (or size range). In at least some embodiments, lowest total cost may comprise lowest total cost for a given plan size (or size range) and given types of investments (or investment range).

In at least some embodiments, the method may further include automatically determining investment mapping at least in part and/or providing one or more graphical tools, which may be activated by an advisor and/or other user to indicate a requested investment mapping at least in part. In at least some embodiments, performing investment mapping prior to comparing costs associated with plans helps to increase the accuracy of the comparison.

In at least some embodiments, the method may further include providing one or more graphical tools, which may be activated by an advisor and/or other user to indicate a request for ongoing monitoring of plan fees.

As stated above, various features of at least some embodiments and/or other aspects of the invention address the following and other concerns: total cost of a retirement plan; breaking down the total costs into those incurred by the investment options and costs related to servicing the plan, whether the costs of a retirement plan are reasonable or competitive with other plans; documenting a prudent procedure for selection and management and monitoring of a retirement plan's fees and investment options.

In at least some embodiments, any one or more graphical tools that is disclosed herein and activatable by a user to indicate a request, a selection and/or other information may be supplemented and/or replaced by a tool that is not a graphical tool in a graphical user interface but yet activatable by a user to indicate the request, the selection and/or the other information.

In at least some embodiments, the method may further include any one or more other methods, or portions thereof, disclosed herein

In at least some embodiments, a computer program or machine instruction set can allow for signing into an existing user account or creating a new account. A user can be a plan administrator or a financial planner or a third party administrator (TPA). The users may be sent invitations by an email or electronic link or tag so access their accounts using authenticated login credentials. In an aspect, the users may be able to login from a secure social media or similar network that supports user authentication.

In another aspect, a financial planner or third party can be provided with only limited access to a subset of information or controls under a given account. For example, a third party may only be able to access portions of the system relating to that third party's services or funds or plans.

In yet another aspect, providers may be ranked in a determined order. The ranking can be based on a method automatically carried out in the system. The ranking is sometimes arranged and adapted to output an ordered list of providers or plans based on one or more criteria.

A provider may be able to view a list of a plurality of clients he or she is servicing. Client opportunities are also presented to an advisor in some examples. For example, an advisor may be presented with a listing of opportunities from a database accessible to the present system. The database may contain the plan name, plan assets, annual contributions, as-of date, number of participants, fees, and information about the company where the participants are employed. Some of the foregoing information, and others, are obtained from an automatically recognized or parsed or processed form, e.g., 408(b)(2) form. Processing and loading of information may be accomplished using optical character recognition (OCR) engine technology in a server or a local computing device. In an aspect, a user can upload or scan and deliver or email an electronic copy of such 408(b)(2) form, or equivalent, to a server, e.g., in a cloud based architecture. Utilizing OCR to capture the current investment options and searching to determine the specific fund categories of each option. Once the categories are identified and the percentage of plan assets in each category are determined, other financial firms are able to propose an investment option for that category so that a comparison of investment fees and performance can be done. This allows for a true comparison of total fees. Once the fees are ascertained they can be broken down into cost for investments and costs for services. Comparisons of costs can be done in dollar amounts in some embodiments, and in others can be viewed as a percent value.

In yet another embodiment, commission and accounting data is processed to determine an advisor's compensation from a given transaction. These and other objects and goals of at least some embodiments of the present invention are not found in current systems, especially those accessible to and used by small business managers, leaving these individuals and businesses under-served by the retirement plan industry, and leaving the fiduciaries of the same exposed to risk.

In further aspects, the method and system can devise one or more fund categories to allocate investments among. A plurality of available fund types (e.g., large cap, mid value, international, bond, target date, small growth, etc.) are selectable for allocation, by percent or other formula.

In yet other embodiments, the method and system is configured to generate a template for a given provider or plan. Data may be automatically or manually entered into said template, e.g., to populate the template by costs, expenses, other fees, and the template can be used to fill in user interface screens of data or to perform further analyses and comparisons. A provider or plan can then be recommended, non-recommended, or ranked against others to ensure compliance and risk reduction to a manager of a plan.

In at least some embodiments, a plan or aspects of a plan may be presented in a heat map or other visual spectrum or comparative chart for ease of understanding of the benefits and risks of a plan compared to others or compared to an average. One aspect that can be plotted or presented as such is fees and costs of a selected provider against potential other providers. In yet another particular example, the user interface of the present system can present a user with computed savings resulting from a hypothetical use or switch between one provider and another, integrated over time (e.g., one or more years in the future). Those skilled in the art will appreciate that other metrics such as broker commissions, investment cost, and other variable factors can be selected for analysis and presentation. An advisor can review, generate outputs and send the same to a client in some embodiments.

In addition, a benchmark or benchmarking step may be carried out, for example if an account or plan does not have a 408(b)(2) document or existing stored data for an account or plan. In some examples, if data is missing but required to arrive at a recommendation or understanding, the system and method may employ rules, e.g., in a rules engine, so as to substitute, extrapolate, interpolate, or otherwise compensate for such missing data and still accomplish the desired result.

In other instances, a fiduciary certificate can be generated and presented or sent to a recipient. Results and reports can be generated to show results of a recommendation or analysis in a selected order, e.g., by lowest cost, lowest fees, historical performance, record keeping record, and so on. Top choices can be presented or highlighted among the available options as desired. For example, the top 5 or 10 best plans can be presented in a descending order.

In some aspects, the system and method not only analyzes and presents data and recommendations to users, but can additionally assist a user in signing up for or switching to a selected plan. This includes preparation of necessary electronic documents, collecting needed e-signatures, etc.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in field programmable gate arrays (FPGAs) or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

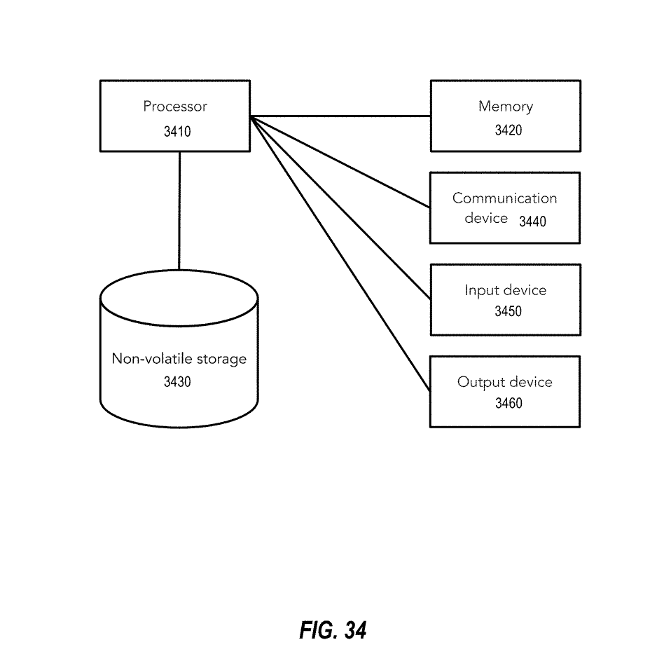

FIG. 34 is a block diagram of a computer architecture 3400 according to some embodiments. In some embodiments, one or more of the systems (or portion(s) thereof), apparatus (or portion(s) thereof) and/or devices (or portion(s) thereof) disclosed herein may have an architecture that is the same as and/or similar to one or more portions of the architecture 3400.

In some embodiments, one or more of the methods (or portion(s) thereof) disclosed herein may be performed by a system, apparatus and/or device having an architecture that is the same as or similar to the architecture 3400 (or portion(s) thereof). The architecture may be implemented as a distributed architecture or a non-distributed architecture.

Referring to FIG. 34, in accordance with at least some embodiments, the architecture 3400 may include one or more processors 3410 and one or more articles of manufacture that comprise non-transitory computer-readable storage media (e.g., memory 3420 and one or more non-volatile storage media 3430). The processor 3410 may control writing data to and reading data from the memory 3420 and the non-volatile storage device 3430 in any suitable manner, as the aspects of the disclosure provided herein are not limited in this respect. The storage media may store one or more programs and/or other information for operation of the architecture 3400. In at least some embodiments, the one or more programs include one or more instructions to be executed by the processor 3410 to provide one or more portions of one or more tasks and/or one or more portions of one or more methods disclosed herein. In some embodiments, other information includes data for one or more portions of one or more tasks and/or one or more portions of one or more methods disclosed herein. To perform any of the functionality described herein, the processor 3410 may execute one or more processor-executable instructions stored in one or more non-transitory computer-readable storage media (e.g., the memory 3420), which may serve as non-transitory computer-readable storage media storing processor-executable instructions for execution by the processor 3410.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more communication devices 3440, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices 3450 and/or one or more output devices 3460. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

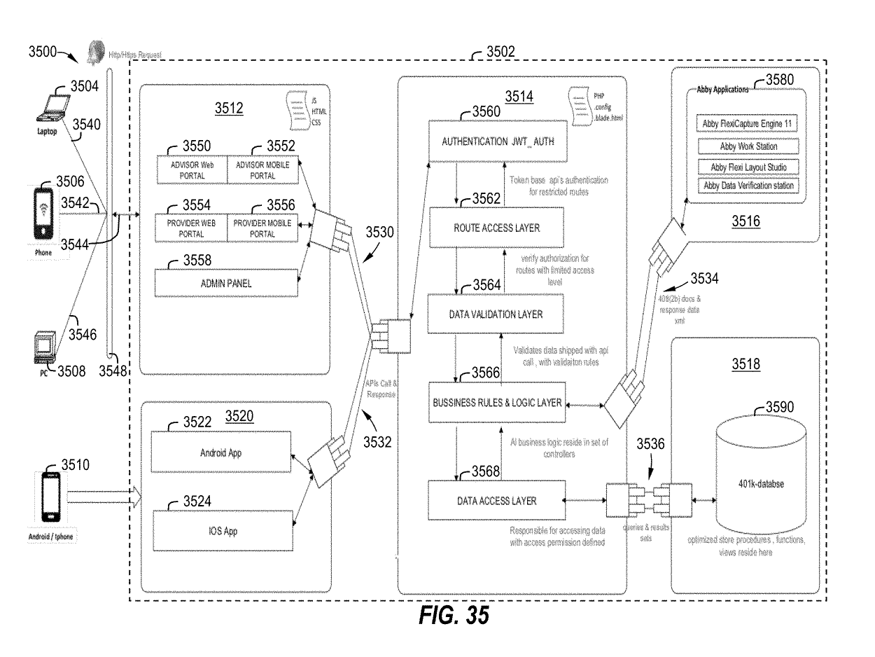

FIG. 35 is a block diagram of a system architecture 3500, according to some embodiments.

In at least some embodiments, one or more of the systems (or portion(s) thereof), devices (or portion(s) thereof) or any other apparatus (or portion(s) thereof) disclosed herein may have an architecture that is the same as and/or similar to the architecture of the system architecture 3500 or portion(s) thereof.

In at least some embodiments, the architecture 80 (FIG. 8) or portion(s) thereof may have an architecture that is the same as and/or similar to the architecture of the system architecture 3500 or portion(s) thereof.

In at least some embodiments, one or more of the methods (or portion(s) thereof) disclosed herein may be performed using the system architecture 3500 (or portion(s) thereof). The system architecture 3500 may be implemented as a distributed architecture or a non-distributed architecture.

Referring to FIG. 35, the system architecture 3500 includes a processing system 3502 and a plurality of mobile or other devices, e.g., devices 3504-3510, which may be operated by one or more users (not shown).

The devices 3504-3510 (sometimes referred to herein as user devices) may comprise a laptop computer, a mobile phone, a desktop computer and/or any other type of device(s).

The processing system 3502 may include a front end 3512, a back end 3514, a data and/or document capture system 3516 and a database or other storage system 3518.

The processing system 3502 may further include one or more programs 3520, sometimes referred to as mobile applications, which may reside in and may be executed by one or more of the devices 3504-3510, e.g., the mobile phone 3510. One of the one or more programs 3520, e.g., program 3522, may be a mobile application configured to reside in and be executed by a mobile device (e.g., an ANDROID device) that executes an ANDROID operating system. Another of the one or more programs 3520, e.g., program 3524, may be a mobile application configured to reside in and be executed by a mobile device (e.g., an iPhone) that executes an IOS operating system.

One or more communication links, e.g., communication links 3530-3536, may couple the various portions of the processing system 3502.

Additionally, one or more other communication links, e.g., communication links 3540-3548, may couple one or more of the user devices, e.g., user devices 3504-3508, to the front end 3512 or one or more other portions of the processing system 3502. In some embodiments, one or more of the communication links may comprise a network, e.g., a wide area network such as for example, the Internet and/or a cellular network.

The front end 3512 may include one or more portals 3550-3556 (to allow advisors and/or providers to access the processing system 3502) and an administrator interface 3558 (sometimes referred to herein as an administrator panel 3558). The one or more portals 3550-3556 may include an advisor web portal 3550, an advisor mobile portal 3552, a provider web portal 3554 and a provider mobile portal 3556. In some embodiments, one or more of the portals and administrator interface may comprise instructions written in JAVA SCRIPT, HTML, CSS and/or any other programming language(s).

The front end 3512 may reside on one or more servers configured to execute the above instructions to provide the above portals and administrator interface. The one or more servers may execute one or more computer programs configured to provide a front end web application platform, e.g., an ANGULAR JS and/or ANGULAR 4 front end web application program.

In at least some embodiments, one or more of the devices 3504-3508 may be operated by and/or otherwise associated with an advisor and/or provider. In at least some embodiments, one or more other devices, e.g., mobile device 3510, may be operated by and/or otherwise associated with a client of the advisor.

The back end 3514 may include a plurality of layers 3560-3568. The plurality of layers may include an authentication layer 3560, a route access layer 3562, a data validation layer 3564, a rules and logic layer 3566 and a data access layer 3568. In some embodiments, one or more of the back end layers 3560-3568 may comprise instructions written in PHP, .CONFIG and/or .BLADE.HTML files and/or any other programming language(s).

The back end 3514 may reside on one or more servers configured to execute the above instructions to provide the above layers 3560-3568. The one or more servers may execute one or more computer programs configured to provide a back end development platform, e.g., a LARAVEL REST back end development platform.

The data and/or document capture system 3516 may comprise one or more computer programs 3580 configured for data and/or document capture. In some embodiments, the one or more programs may comprise an ABBY FLEXICAPTURE ENGINE or other type data and/or document capture engine, an ABBY WORK STATION or other type work station, an ABBY FLEXI LAYOUT STUDIO or other type of layout studio and/or an ABBYY DATA VERIFICATION STATION or other type data verification station.

The data and/or document capture system 3516 may reside on one or more servers configured to execute the above computer programs 3580. In some embodiments, the one or more servers comprise a server that executes a WINDOWS operating system and/or an ABBY FLEXICAPTURE 11 WEBSERVER.

The database or other storage 3518 may store one or more programs or portion(s) thereof and/or other information. In some embodiments, the one or more programs or portion(s) thereof may comprise procedures, functions and/or views or other types of programs or portion thereof for storing information associated with a plurality of available plans, for generating one or more of the views or portions thereof described herein and/or for performing one or more other functions described herein. In at least some embodiments, the database or other storage 3518 may comprise a database 3590 that stores one or more portions of the above. The database or other storage 3518 may be centralized and/or distributed.

In some embodiments, one or more portions of the processing system 3502 may reside in a cloud, e.g., operated by or on behalf of a cloud provider.

In operation, one or more of the user devices 3504-3508 may generate and/or transmit one or more requests (e.g., HTTP and/or HTTPS requests) and/or other information to the processing system 3502 via the one or more communication links 3540-3548. In some embodiments, the one or more requests and/or other information be associated with one or more portions of one or more methods disclosed herein. One or more portals of the front end 3512 may receive the one or more requests and may generate one or more application programming interface (API) calls, based at least in part thereon. The one or mobile applications 3520 that reside in mobile devices, e.g., mobile device 3510, may also generate application programming interface (API) calls. In some embodiments, the one or more API calls may be associated with one or more portions of one or more methods disclosed herein.

The back end 3514 may receive the one or more API calls, which may be supplied to the authentication layer 3560, which may provide token based API authentication for restricted routes and may provide one or more requests and/or other information based at least in part thereon. The one or more requests and/or other information provided by the authentication layer 3560 may be supplied to the route access layer 3562, which may verify authorization for routes with limited access level and provide one or more requests and/or other information based at least in part thereon. One or more requests and/or other information provided by the route access layer 3562 may be supplied to the data validation layer 3564, which may include validation rules and may use the validation rules to determine whether to validate (or not validate) data shipped with the one or more API calls and provide one or more requests and/or other information based at least in part thereon. One or more requests and/or other information provided by the data validation layer 3564 may be supplied to the business rules and logic layer 3566, which may include one or more controllers that include business logic rules for use in association with analyzing, comparing, selecting or receiving a selection, recording and/or one or more other portions of one or methods disclosed herein. The business rules and logic layer 3566 may provide one or more requests and/or other information based at least in part thereon.

The requests and/or other information provided by the business rules and logic layer 3566 may be supplied to the data access layer 3568 and/or to the data and/or document capture system 3516. Requests and/or other information supplied to the data and/or document capture system 3516 may be associated with 408(2)(b) documents. The data and/or document capture system 3516 may receive the requests and/or other information and may provide one or more response. In some embodiments, one or more portions of the response may comprise XML.

The data access layer 3568 may receive requests and/or other information from the business rules and logic layer 3566 and may provide a request to access data with access permission defined. The request may be supplied to the database and/or other storage 3518, which may provide one or more result sets based at least in part thereon.

The one or more result sets from the database and/or other storage 3518, may be supplied to the data access layer 3568, which may provide results and/or other information based at least in part thereon. Such results and/or other information may be supplied to the business rules and logic layer 3566, which may provide results and/or other information based at least in part thereon. Such results and/or other information may be supplied to the data validation layer 3564, which may provide results and/or other information based at least in part thereon. Such results and/or other information may be supplied to the route access layer 3562, which may provide results and/or other information based at least in part thereon. Such results and/or other information may be supplied to the authentication layer 3560, which may provide a response to the initial API call and/or other information based at least in part thereon. If the initial API call was based at least in part on a request and/or other information from one or more of the devices 3504-3508, the response and/or other information may be supplied to the front end 3512, which may provide a response and/or other information to the one or more devices 3504-3508 that supplied the initial request and/or other information. If on the other hand, the initial API call was provided by one or more device, e.g., device 3510, executing one of the mobile applications 3520, the response and/or other information may be supplied to such device, e.g., device 3510.

As stated above, in at least some embodiments, the investment plan is a 401 K plan.

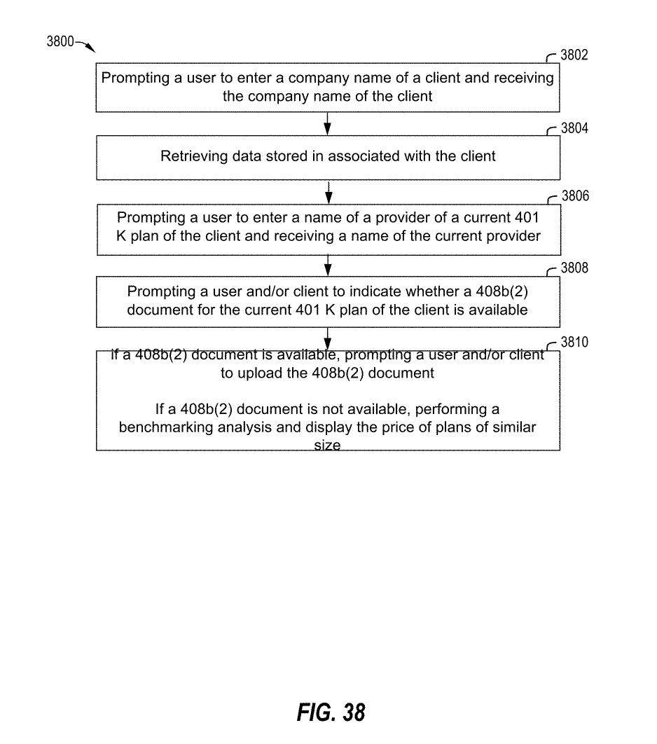

FIG. 38 is a flowchart 3800 of a method that may be performed prior to 3302 (FIG. 33) if the investment plan is a 401 K plan, in accordance with some embodiments.

In at least some embodiments, the method (or one or more portion(s) thereof) may be performed by the device 900.

Referring now to FIG. 38, at 3802, the method may include prompting a user to enter a company name of a client and receiving the company name of the client.

At 3804, the method may further include receiving data stored in association with the company. In at least some embodiments, the data may indicate a plan name, an address of the company, a name of a contact, a phone number associated with the contact, the amount of assets in the plan, the amount of annual contributions to the plan, the number of plan participants, a business code associated with the company, a date that the 401 k plan began at the company and/or a date that the client became a client.

At 3806, the method may further include prompting a user to enter a name of a provider of a current 401 K plan of the client and receiving a name of the current provider.

At 3808, the method may further include prompting a user and/or client to indicate whether a 408b(2) document for the current 401 K plan of the client is available.

At 3810, the method may further include prompting a user and/or client to upload the 408b (2) document if one is available. If a 408b(2) document is not available, the method may include performing a benchmarking analysis and displaying the price of plans of similar size.

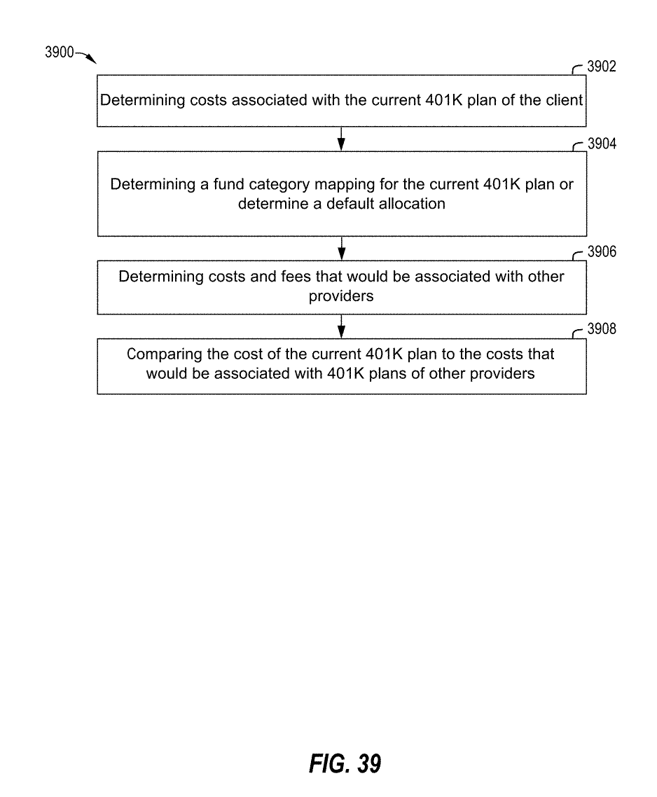

FIG. 39 is a flowchart 3900 of a method that may be performed at 3310 (FIG. 33) if the investment plan is a 401 K plan, in accordance with some embodiments.

In at least some embodiments, the method (or one or more portion(s) thereof) may be performed by the device 900.

Referring now to FIG. 39, at 3902, the method may include determining costs associated with the current 401 K plan of the client.

In at least some embodiments, this may include determining total fees and service fees (which in at least some embodiments, are not included in the total fees) associated with the current 401 K plan of the client.

In at least some embodiments, the costs may be determined based at least in part on the data extracted from the source document (the 408b(2) document) associated with the current 401 K plan of the client.

In at least some embodiments, the selection criteria extracted from a 408b(2) document at 3306 (FIG. 33) may include Total Monthly Plan-Level Optional Service Fees (which may include Monthly Total Recurring Plan-Level RecordKeeping/Administrative Service Fees), Participant Level Processing Fees (which may include Loan Initiation Fee, Benefit Disbursement Lump Sum/Direct Transfer/Withdrawal Fee and Stop Pay/Reissue and Special Handling Fee), Total Asset Weighted Average Net Expense Ratio (which in at least some 408b(2) documents is the amount indicated on line item K), Total Asset Weighted Average Compensation to provider for Services to Investment Funds (which in at least some 408b(2) documents is the amount indicated on line item L).

In one example of such an embodiment, the Monthly Total Recurring Plan-Level RecordKeeping/Administrative Service Fees is $0.00, the Loan Initiation Fee is $125.00 per loan, the Benefit Disbursement Lump Sum/Direct Transfer/Withdrawal Fee is $50.00 per distribution, the Stop Pay/Reissue and Special Handling Fee is $25.00 per stop and reissue, the Total Asset Weighted Average Net Expense Ratio is 1.49%, and the Total Asset Weighted Average Compensation to provider for Services to Investment Funds is 0.85%.

In at least some embodiments, the service fees may be determined as equal to or otherwise based at least in part on the Total Asset Weighted Average Compensation to provider for Services to Investment Funds, which in the example above is 0.85%.

In at least some embodiments, the total fees may be determined as being equal to or otherwise based at least in part on a sum of: (a) the Total Asset Weighted Average Net Expense Ratio, which in the example above is 1.49%, and (b) the annual cost that results from the Monthly Total Recurring Plan-Level RecordKeeping/Administrative Service Fees (i.e., 12×Monthly Total Recurring Plan-Level RecordKeeping/Administrative Service Fees), which in the example above is $0.00. Thus, in the example above, the total fees may be determined as being equal to 1.49% (1.49%+0.0).

In at least some embodiments, the method may further include determining if there are transaction fees associated with the current plan, investment options associated with the current plan, the amount of assets in each investment option, fund category information associated with the current plan and a start date of the current plan.

In at least some embodiments, the transaction fees may be determined as the Loan Initiation Fee, which in the example above is $125.00 per loan, the Benefit Disbursement Lump Sum/Direct Transfer/Withdrawal Fee, which in the example above is $50.00 per distribution, and the Stop Pay/Reissue and Special Handling Fee, which in the example above is $25.00 per stop and reissue.

In at least some embodiments, the method may further include determining the percent of total assets that are in each fund. In at least some embodiments, this may be determined, for each fund, as the amount of assets in the fund divided by the total amount of assets in the plan.

In at least some embodiments, the method may further include performing a search at MORNINGSTAR.COM or at YAHOO FINANCE, aggregating an amount of assets for each fund category and calculating a percent of assets in each fund category.

At 3904, the method may further include determining a fund category mapping for the current 401 K plan or determining a default allocation.

In at least some embodiments, investment data is extracted from the 408b (2) document if the 408b (2) document indicates the amount of assets in each fund. For each fund, a search of the 9000+ mutual funds is performed to determine the category of the fund. Assets may then be aggregated by fund category and a weighted expense may be determined based at least in part thereon.

If the 408b (2) document does not indicate the amount of assets in each fund, a default allocation may be used.

At 3906, the method may further include determining (an estimate of) costs and fees that would be associated with other providers.

In at least some embodiments, determining an estimate of cost and fees that would be associated with another provider includes determining an estimate of cost and fees that would be associated with another provider based at least in part on the current allocation of assets in the current 401 K plan of the client.

Thus, in at least some embodiments, an estimate of cost and fees that would be associated with a given provider is determined based at least in part on data extracted from the 408b (2) document (e.g., indicating the amount of current assets that are allocated to each investment option in the current 401 K plan of the client) and pricing information for the provider. Thus, in at least some embodiments, results from the investment mapping is also used. In some embodiments, the pricing information for the provider has the form of a pricing grid and the estimate of cost and fees is determined by running data extracted from the 408b (2) through the pricing grid for the provider.

In at least some embodiments, costs and fees may be determined for each of the other fifteen (15) providers of 401 K plans.

In at least some embodiments, the provider costs and fees may be determined as a sum of the total investment cost, the provider cost and a broker commission amount.

In at least some embodiments, determining the other provider costs and fees as set forth above enables an accurate estimate on investment cost and/or fees and a weighted historical performance illustration.

At 3908, the method may further include comparing the cost of the current 401 K plan to the costs that would be associated with 401 K plans of other providers.

Those skilled in the art will appreciate many advantages of the present invention(s) and disclosure in solving problems of the prior art in the present field. As described and claimed, this disclosure provides a method for parsing, processing and/or displaying relevant market information in the field of managing financial instruments and choosing plans such as retirement plans. The current state of the art is rife with inconsistent and inaccurate decision making, inadequate due diligence results, and other variations in handling financial planning and retirement fund choice activities. The state of the art technology, hardware, software, data repositories and user interfaces are incapable of carrying out the presently-disclosed methods and inventions.

The present method for automated review, processing, manipulating and generating data, documents and user interface elements more consistently and accurately achieve acceptable decisions in the field of retirement planning options review and selection and presentation in a technical environment to a user or employer or manager. The method automatically, using the underlying technical components described herein, dynamically displays relevant content, based on source documents and/or files and/or human-entered information. The method automatically, using the underlying technical components described herein, dynamically processes the above source documents and/or files and/or human-entered information. The method further automatically, using the technical components described herein, processes and parses in a processing circuit, portions of a computer-readable information, derived using an optical or other electronic means of deriving the computer-readable information. Prior systems uses in the present field were not configured, adapted, arranged, programmed or capable of extraction, parsing and processing the myriad types of source materials as disclosed herein so as to generate the relevant and consistent sets of machine-readable information required by the above rules so as to dynamically compare various plans, or to generate and display output signals, using the present technical components, so as to create a digital or physical certificate (e.g., an electronic file comprising encoded and stored signals such as in a magnetic or optical storage device, a viewable image comprising output pixels on a display screen, or paper documents having output information printed thereon).

Thus, the present disclosure and claims include new and novel improvements to existing methods and technologies, which were not previously known nor implemented to achieve the useful results described above. Users of the present method and system will reap tangible benefits from the functions now made possible on account of the specific modifications described herein causing the effects in the system and its outputs to its users. It is expected that significantly improved operations can be achieved upon implementation of the claimed invention, using the technical components recited herein, insofar as managers of retirement accounts can effectively and safely carry out their duties with regard to comparing and choosing a retirement plan. Again, the many retirement plan options available are generally in the prior art presented inconsistently and there is no known prior technology or method for accurately and consistently comparing and processing such available plan information to achieve an acceptable recommendation output for those considering a choice of plans, e.g., to their employees. The functionality available by this invention, which overcomes problems in the present field, is directly attributable to the present technical modifications and innovations to a data processing system and architecture, including to its processors, programmed instruction sets, data storage and user interface elements. This overall structure and implementation in the present technical infrastructure dramatically improves and makes more accurate the previously-ad hoc process for comparing and choosing retirement plan options.

In aspects, the method uses machines configured and loaded with data, signals or similar instructions and indicia to implement a set of electronic steps corresponding to rules required or desired in the field of financial or retirement planning, previously not known nor available to persons practicing in the field, and not possible before configuration of the underlying technical components described herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

It should be understood that the features disclosed herein can be used in any combination or configuration. Thus, for example, in some embodiments, any one or more of the features disclosed herein may be used without any one or more other feature disclosed herein.

Unless stated otherwise, a computing device is any type of device that includes at least one processor.

Unless stated otherwise, a processing device is any type of device that includes at least one processor.

Unless stated otherwise, a processing system is any type of system that includes at least one processor.

Unless stated otherwise, a mobile (or portable) computing device includes, but is not limited to, any computing device that may be carried in one or two hands and/or worn.

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low-level language code, high-level language code, microcode), firmware, and/or any combination thereof.

Unless stated otherwise, a program may include, but is not limited to, instructions in a high-level language, low-level language, machine language and/or other type of language or combination thereof.

Unless stated otherwise, a “communication link” may comprise any type(s) of communication link(s), for example, but not limited to, wired links (e.g., conductors, fiber optic cables) or wireless links (e.g., acoustic links, radio links, microwave links, satellite links, infrared links or other electromagnetic links) or any combination thereof, each of which may be public and/or private, dedicated and/or shared. In some embodiments, a communication link may employ a protocol or combination of protocols including, for example, but not limited to the Internet Protocol.

Unless stated otherwise, information may include data and/or any other type of information.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A method, comprising:
receiving, at a processor, a source document that includes human readable information regarding an investment plan;
generating, by said processor, a computer readable file, corresponding to said source document, including computer readable information regarding the investment plan based at least in part on the human readable information;
parsing, by said processor, portions of the computer readable information to extract one or more selection criteria for said investment plan;
receiving, at said processor, from a data store containing information regarding other investment plans, selection criteria for said other investment plans, and determining or receiving for said other investment plans, selection criteria for said other investment plans;
comparing, by said processor, the selection criteria of the investment plan with comparable selection criteria of said other investment plans;
generating, from said processor, an output signal indicative of a result of said comparing step above, and identifying a selected investment plan from a group of available investment plans including the investment plan and the other investment plans;
outputting, from said processor an electronic file comprising a record of the selection made; and
generating a certificate certifying said comparison and said selection.

2. The method of claim 1, further comprising generating, by said processor, a record of the one or more characteristics of the plan.

3. The method of claim 1, wherein the selected investment plan is a 401 k plan.

4. The method of claim 1, wherein the selection criteria include a cost metric.

5. The method of claim 1, wherein the generating said certificate comprises executing in said processor one or more steps required under a regulatory scheme for due diligence in choosing plans among available plans.

6. At least one non-transitory computer readable storage medium storing processor-executable instructions that, when executed by at least one processor, result in a method comprising:
receiving a source document that includes human readable information regarding an investment plan;
generating a computer readable file, corresponding to said source document, including computer readable information regarding the investment plan based at least in part on the human readable information;
parsing portions of the computer readable information to extract one or more selection criteria for said investment plan;
receiving from a data store containing information regarding other investment plans, selection criteria for said other investment plans, and determining or receiving for said other investment plans, selection criteria for said other investment plans;
comparing the selection criteria of the investment plan with comparable selection criteria of said other investment plans;
generating an output signal indicative of a result of said comparing step above, and identifying a selected investment plan from a group of available investment plans including the investment plan and the other investment plans;
outputting an electronic file comprising a record of the selection made; and
generating a certificate certifying said comparison and said selection.

7. The at least one non-transitory computer readable storage medium of claim 6, wherein the method further comprises generating a record of the one or more characteristics of the plan.

8. The at least one non-transitory computer readable storage medium of claim 6, wherein the selected investment plan is a 401 k plan.

9. The at least one non-transitory computer readable storage medium of claim 6, wherein the selection criteria include a cost metric.

10. The at least one non-transitory computer readable storage medium of claim 6, wherein the generating said certificate comprises executing one or more steps required under a regulatory scheme for due diligence in choosing plans among available plans.

11. A system comprising:
at least one computer hardware processor configured to execute instructions that result in a method comprising:
receiving a source document that includes human readable information regarding an investment plan;
generating a computer readable file, corresponding to said source document, including computer readable information regarding the investment plan based at least in part on the human readable information;
parsing portions of the computer readable information to extract one or more selection criteria for said investment plan;
receiving from a data store containing information regarding other investment plans, selection criteria for said other investment plans, and determining or receiving for said other investment plans, selection criteria for said other investment plans;
comparing the selection criteria of the investment plan with comparable selection criteria of said other investment plans;
generating an output signal indicative of a result of said comparing step above, and identifying a selected investment plan from a group of available investment plans including the investment plan and the other investment plans;
outputting an electronic file comprising a record of the selection made; and
generating a certificate certifying said comparison and said selection.

12. The system of claim 11, wherein the method further comprises generating a record of the one or more characteristics of the plan.

13. The system of claim 11, wherein the selected investment plan is a 401 k plan.

14. The system of claim 11, wherein the selection criteria include a cost metric.

15. The system of claim 11, wherein the generating said certificate comprises executing one or more steps required under a regulatory scheme for due diligence in choosing plans among available plans.
